(19) United States
(12) Patent Application Publication
(10) Pub. No.: US 2012/0257042 A1
(43) Pub. Date: Oct. 11, 2012

(54) System for scanning, mapping and measuring conduits

(75) Inventors: Shaun McKaigue, Gilford (CA); Vadim Kosseniouk, Richmond Hill (CA)

(73) Assignee: FER-PAL CONSTRUCTION LTD

(21) Appl. No.: 13/064,680

(22) Filed: Apr. 8, 2011

(51) Int. Cl. H04N 7/18

(52) U.S. Cl. 348/84; 348/E07.087

(57) ABSTRACT

The present invention relates to a system for scanning, mapping and measuring conduits. The system includes a data collection subsystem having a carriage assembly sized to fit within a conduit for travel therethrough and equipment module supported on the carriage assembly. The equipment module includes a housing, a video capture system and a lighting assembly accommodated within the housing, and a laser beam emitting and diffusion assembly attached to the housing forwardly of the video capture system. The laser beam emitting and diffusion assembly is operable to emit a laser beam and diffuse the laser beam along a plane P substantially perpendicular to the laser beam so as to trace a visible light contour where the plane P intersects the inner surface of the conduit. The laser beam is a light of a first colour. The video capture system is operable to record images of the conduit and the visible light contour generated by the laser beam emitting and diffusion assembly. The lighting assembly includes at least one LED light capable of emitting light of a second colour. The light of the second colour is different than the light of the first colour. The light of the second colour is selected so as provide sufficient illumination within the conduit to reveal features of the conduit when the at least one LED light is activated, while not substantially lessening the contrast of the visible light contour against the dark background formed by the conduit thereby allowing the images of the visible light contour of a sufficient quality to be captured for further processing. The system is further provided with a data processing subsystem that is in data communication with the data collection subsystem. The data processing subsystem being operable to process the images of the conduit and the visible light contour and to generate therefrom digital views of the conduit.

### FIELD OF THE INVENTION

The present invention relates to a system for scanning, mapping and measuring conduits.

### BACKGROUND OF THE INVENTION

Inspection is an important part of maintenance and rehabilitation programs for underground infrastructure, such as, water, gas or sewer mains or conduits. Various types of devices have been developed to carry out such inspections. These devices may have wheels and may be self-propelled. Alternatively, they may be designed to be pulled or dragged through the conduit. The inspection work may be performed using X-rays, magnetic particle imaging (MPI) or infra-red scanning. Some inspection vehicles include camera systems (i.e. video cameras or still photography cameras) for providing images of the inner space of the conduit.

An example of such a conduit inspection apparatus is described and shown in U.S. Pat. No. 7,164,476. The apparatus includes two parts—a pipeline inspection probe, and a control unit comprising at least one computer or data processor software. The patent describes that the pipeline inspection probe may be carried on a mover which could be a sled or slide for sliding or pulling or pushing the probe through the pipeline. The pipeline inspection probe includes a probe body and an optical sensor in the nature of a video or CCD camera (or 3CCD camera) and associated lens (preferably, a fish-eye lens). The fish-eye lens associated with the camera enables the viewing of forward views of the pipeline interior in wide angle radius scans (preferably, 360 degrees). The apparatus further includes a light or light source, which is preferably at least one and most preferably multiple LED lights which are preferably evenly spaced from each other. The lights illuminate the interior of the pipeline so that views taken by the camera may be clearly seen. In one embodiment, the LED lights are disposed along a ring around the fish-eye lens of the camera.

The apparatus preferably has associated therewith a distance meter or measurer for measuring or determining the distance of the probe in the pipeline when the various views of the pipeline are taken. Also provided, is a gyroscope sensor associated with the probe or the camera for identifying the exact location and direction of the camera in the pipeline which in turn allows for identity of the exact location of a pipeline defect seen with the camera.

In one embodiment of the invention, the pipeline inspection probe automatically takes a forward view of the pipeline interior at desired distance intervals as the probe (with camera) moves along the pipeline. In an alternative embodiment, the probe automatically takes digitized forward and side-scan views of the pipeline interior wall as the probe (with camera) moves along the pipeline. The patent describes a side-scan view as being an “unfolded image”—a two-dimensional representation of a three-dimensional pipe which is equivalent to cutting the pipe and unfolding it and laying it out flat.

The data processing part of the apparatus uses the data collected to provide the field operator with a quasi-three-dimensional understanding of the internal view of the pipeline. All the data collected is fed into a computer which has data processing software that enables it to digitize and manipulate the data and outputs from the field data collection part of the apparatus, display the results and save the data for further analysis, further evaluation, or for use with pipeline infrastructure maintenance software as desired. The software generates forward (or frontal) views and side-scan views of the pipe in real-time for display on a computer monitor. Connection between the probe and the computer is made through appropriate cabling for transport of data to the computer, although wireless communication may be possible in some applications.

Another example of a conduit inspection system appears in U.S. Pat. No. 6,931,149. This patent described and shows a pipeline inspection gauge (or PIG). The PIG has a pressure resistant housing (provided with windows made of a transparent material) in which there are arranged optical components, such as an optical source for generating a beam of light and an optical recording unit, for example, a camera for recording images. The beam of light generated inside the housing is directed through a first transparent window and onto the inside of a part of a pipe or pipeline. The light source is adapted to form one or more fan shaped beams of light which define or illuminate a line profile L on an interior surface part of the pipeline. The surface anomalies or irregularities in the pipe disrupt an otherwise circular form of the line profile L. The fan-shaped beam may be obtained by placing a cylindrically-shaped lens in front of the optical source. Other optical components for shaping or forming the light from the optical source into substantially fan-shaped beams could also be used. The light source is preferably a laser but the reference contemplates that an LED array could also be used. The reference teaches that the use of several lasers is required because of power considerations.

A camera or other optical receiving means is positioned outside the plane formed by the fan shaped beams for receiving part of the emitted light which is reflected from the inner surface of the pipeline wall. The light source means and the optical receiving means are arranged to have their optical axes at an angle of between 0 to 90 degrees, preferably, between 30 to 60 degrees with respect to each other. Several light sources and corresponding cameras may be arranged to illuminate and image around the inner periphery of the pipeline. Each pair of light source and camera is associated with corresponding fan shaped beams of light and corresponding fields of view of the cameras. The camera is adapted to form a plurality of two-dimensional images. Each image includes intensity data for a predetermined number of pixels in each of a predetermined number of lines of said image.

The PIG is also provided with a data processing unit which includes an image analyzer module with a surface depth profile analyzer module. The depth profile analyzer module is arranged for extracting a depth profile of the pipe surface from the recorded image by searching for intensity maxima along each selected line of the image.

The patent teaches that by moving the camera and laser system a small distance, recording the image and placing the consecutively recorded images next to each other, a continuous still image of the pipe wall as well as a continuous 3D dimension maps from the data, may be formed.

While the conduit inspection systems described in U.S. Pat. Nos. 6,931,149 and 7,164,476 are operable to gather certain data relating to the inner surface of the conduit and defects or points of interest thereon, and to display such data in a useful manner, these systems appear to be primarily focused on mapping the location of defects or points of interest within a conduit. These systems do not appear to provide any meaningful information on the size (or diameter) of the conduit along its length.

Based on the foregoing, there appears to be a real need for a system capable of measuring the diameter of the conduits at any given point within the conduits, while rapidly scanning and mapping the interior surface of conduits for easy location of points of interest within the conduit.

Recently, laser profiling systems have been used to determine the ovality, alignment, diameter and capacity of a pipe. One such laser profiling system includes a closed circuit camera inspection unit provided with a laser probe attached to its front end. The laser probe projects a red laser beam in a radial plane perpendicular to the camera's line of sight to form a ring of light on the inside wall of the pipe. The camera captures video images of the ring of light, which are then processed by software to generate a digital pipe profile and provide measurements of faults and other features inside the pipe.

To enhance the accuracy of the laser profiling system, it is preferred that that the laser probe be used under conditions of darkness to allow the red laser light profile to properly stand out and be more visible for detection by the software. Under such operating conditions, the raw unprocessed video footage captured by the closed circuit camera may not be very useful on its own, since internal details of the pipe may not be clearly visible due to the low light conditions. In conditions where the operator requires good quality, raw video footage to assist in locating features of interest within the pipe (for instance, locating a corporation stop after a conduit has been rehabilitated using cured-in-place pipe lining techniques), it may be necessary to have the laser profiling system run two separate passes within the pipe being inspected. For example, during the first pass the laser probe could be energized and the camera could capture images of the red laser light profile of the pipe wall. During the second pass, the laser probe could be de-activated and the pipe could be illuminated to permit detailed video footage of the pipe interior to be captured. Alternatively, the order of these passes could be reversed. Running two inspection passes tends not to be advantageous because it doubles the inspection time for each pipe. Moreover, it can create data correlation issues when data from the first inspection pass is merged with data from the second inspection pass.

In light of the foregoing, it would be advantageous to have a system capable of collecting data relating to the interior of a conduit using laser profiling techniques for further processing, while permitting the capture of good quality raw video footage of the conduit. Such a system would be very beneficial to those executing maintenance and rehabilitation programs for underground conduits and the like, and in particular, would tend to facilitate the often difficult task of determining the location of a corporation stop with some accuracy after a conduit has been rehabilitated by cured-in-place pipe lining.

### SUMMARY OF THE INVENTION

According to a broad aspect of an embodiment of the present invention, there is provided a system for scanning, mapping and measuring conduits. The system includes a data collection subsystem having a carriage assembly sized to fit within a conduit for travel therethrough and equipment module supported on the carriage assembly. The equipment module includes a housing, a video capture system and a lighting assembly accommodated within the housing, and a laser beam emitting and diffusion assembly attached to the housing forwardly of the video capture system. The laser beam emitting and diffusion assembly is operable to emit a laser beam and diffuse the laser beam along a plane P substantially perpendicular to the laser beam so as to trace a visible light contour where the plane P intersects the inner surface of the conduit. The laser beam is a light of a first colour. The video capture system is operable to record images of the conduit and the visible light contour generated by the laser beam emitting and diffusion assembly. The lighting assembly includes at least one LED light capable of emitting light of a second colour. The light of the second colour is different than the light of the first colour. The light of the second colour is selected so as provide sufficient illumination within the conduit to reveal features of the conduit when the at least one LED light is activated, while not substantially lessening the contrast of the visible light contour against the dark background formed by the conduit thereby allowing the images of the visible light contour of a sufficient quality to be captured for further processing. The system is further provided with a data processing subsystem that is in data communication with the data collection subsystem. The data processing subsystem being operable to process the images of the conduit and the visible light contour and to generate therefrom digital views of the conduit.

In one feature, the light of the first colour is red and the light of the second colour is blue. In another feature, the lighting assembly includes a plurality of LED lights. The at least one LED light is a first LED light. The plurality of LED lights includes a second LED light capable of emitting light of a third colour. The light of the third colour is different than the light of the second colour. In a further feature, the light of the third colour is white.

In still another feature, the lighting assembly includes a first set of LED lights capable of emitting light of the first colour and a second set of LED lights capable of emitting light of the second colour. The at least one LED light forms part of the first set of LED lights. The LED lights of the first and second sets are disposed in an alternating fashion about the front of the housing. Additionally, the first set of LED lights includes first, second and third LED lights and the second set of LED lights includes fourth, fifth, sixth and seventh LED lights.

In an alternative feature, the light of the first colour is blue and the light of the second colour is red.

In yet another feature, the carriage assembly includes a cradle and a plurality of leg assemblies supporting the cradle. The plurality of leg assemblies is selected from the group consisting of: (a) adjustable leg assemblies; and (b) non-adjustable leg assemblies. In a further feature, the plurality of leg assemblies includes first, second and third leg assemblies. The third leg assembly is disposed between the first and the second leg assemblies.

In an additional feature, each leg assembly of the plurality has a runner member configured to bear against the inner surface of the conduit, a scissor-leg arrangement and a bracket member for attaching the runner member to the scissor leg-arrangement.

In still another feature, the video capture system includes a wide angle lens operatively connected to a video camera.

In a further feature, the laser beam emitting and diffusion assembly includes a laser beam emitting unit and mirror prism assembly for diffusing the laser beam produced by the laser beam emitting unit.

In another feature, the data processing subsystem includes a computer system disposed at a location selected from the group consisting of: (a) a location physically proximate the conduit and (b) a location remote from the conduit.

In yet another feature, the data collection subsystem is in real-time data communication with the data processing subsystem. Additionally, the real-time data communication between the data collection subsystem and the data processing subsystem is achieved using a connection selected from the group consisting of: (a) a wired connection; and (b) a wireless connection.

According to another broad aspect of an embodiment of the present invention, there is provided a method of scanning and mapping a conduit, the method including the step of providing a conduit mapping and scanning system. The system includes a data collection subsystem and a data processing subsystem in data communication with the data collection subsystem. The data collection subsystem has a carriage assembly sized to fit within a conduit for travel therethrough and an equipment module supported on the carriage assembly. The equipment module includes a housing, a video capture system and a lighting assembly accommodated within the housing, and a laser beam emitting and diffusion assembly attached to the housing forwardly of the video capture system. The laser beam emitting and diffusion assembly is capable of emitting light of a first colour. The lighting assembly includes at least one LED light capable of emitting light of a second colour. The light of the second colour is different than the light of the first colour. The method further includes the steps of: moving the carriage assembly through the conduit; illuminating the conduit with the at least one LED light; emitting from the laser beam emitting and diffusion assembly a laser beam and diffusing the laser beam along a plane P substantially perpendicular to the laser beam; tracing a visible light contour on the conduit where the plane P intersects the inner surface of the conduit; and recording images of the conduit and the visible light contour using the video capture system as the carriage assembly moves through the conduit. The recorded images show the conduit sufficiently illuminated to reveal features of the conduit and the visible light contour sufficiently contrasted against the dark background formed by the conduit. The method also includes the steps of processing the recorded images of the conduit and the visible light contour and generating therefrom digital views of the conduit.

According to yet another broad aspect of an embodiment of the present invention, there is provided a method of locating a corporation stop in a conduit rehabilitated with a cured-in-place pipe liner, the method including the step of providing a conduit mapping and scanning system. The system includes a data collection subsystem and a data processing subsystem in data communication with the data collection subsystem. The data collection subsystem has a carriage assembly sized to fit within a conduit for travel therethrough and an equipment module supported on the carriage assembly. The equipment module includes a housing, a video capture system and a lighting assembly accommodated within the housing, and a laser beam emitting and diffusion assembly attached to the housing forwardly of the video capture system. The laser beam emitting and diffusion assembly is capable of emitting light of a first colour. The lighting assembly includes at least one LED light capable of emitting light of a second colour. The light of the second colour is different than the light of the first colour. The method further includes the steps of: moving the carriage assembly through the conduit; illuminating the conduit with the at least one LED light; emitting from the laser beam emitting and diffusion assembly a laser beam and diffusing the laser beam along a plane P substantially perpendicular to the laser beam; tracing a visible light contour on the conduit where the plane P intersects the inner surface of the conduit; and recording images of the conduit and the visible light contour using the video capture system as the carriage assembly moves through the conduit. The recorded images show the conduit sufficiently illuminated to reveal features of the conduit and the visible light contour sufficiently contrasted against the dark background formed by the conduit. The method also includes the steps of processing the recorded images of the conduit and the visible light contour and generating therefrom digital views of the conduit; and visually identifying the location of the corporation stop from the recorded images of the conduit and the digital views of the conduit.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1a is a conceptual, partially broken away, side elevation view of a conduit scanning, mapping and measuring system in accordance with an embodiment of the present invention deployed in a conduit being examined;

FIG. 1b is a rear perspective view of the conduit scanning, mapping and measuring system shown in FIG. 1a deployed in a conduit to being examined, a portion of the conduit wall being removed and the remainder of the conduit being shown transparent, to reveal details of the system deployed within the conduit;

FIG. 2 is a perspective view of a data collection subsystem in accordance with a first embodiment of the invention, showing an equipment module supported on a carriage assembly and the scissor leg assemblies of the carriage assembly depicted in an extended position;

FIG. 3 is a side elevation view of the data collection subsystem shown in FIG. 2;

FIG. 4 is top plan view of the data collection subsystem shown in FIG. 2;

FIG. 5 is a front end view of the data collection subsystem of FIG. 2 shown deployed in a large-diameter conduit;

FIG. 6 is a perspective view of the data collection subsystem similar to that shown in FIG. 2, except that the scissor leg assemblies of the carriage assembly are depicted in a retracted position;

FIG. 7 is a side elevation view of the data collection subsystem shown in FIG. 6;

FIG. 8 is top plan view of the data collection subsystem shown in FIG. 6;

FIG. 9 is a front end view of the data collection subsystem of FIG. 6 shown deployed in a small-diameter conduit;

FIG. 10 is another perspective view of the data collection subsystem of FIG. 2 showing the equipment module exploded from the carriage assembly and a protective tubular casing exploded from the equipment module;

FIG. 11 is a perspective view of the carriage assembly shown in FIG. 10;

FIG. 12 is a top plan view of the cradle of the carriage assembly shown in FIG. 11;

FIG. 13 is a rear bottom right perspective view of the cradle shown in FIG. 12;

FIG. 14 is a perspective view of the equipment module shown in FIG. 10 with the protective tubular casing omitted therefrom to better reveal details of the equipment module;

FIG. 15 is an exploded perspective view of the equipment module shown in FIG. 14;

FIG. 16 is a rear perspective view of the body of the front cover assembly shown in FIG. 15;

FIG. 17 is a cross-sectional view of the laser beam emitting and diffusion system shown in FIG. 15;

FIG. 18 is a perspective view of a data collection subsystem in accordance with a second embodiment of the invention;

FIG. 19 is a front end view of the data collection subsystem of FIG. 18 shown deployed in a small-diameter conduit;

FIG. 20 is another perspective view of the data collection subsystem of FIG. 18 showing the equipment module exploded from the carriage assembly;

FIG. 21 illustrates a computer system of the data processing system having image processing software in accordance with an embodiment of the invention, residing thereon;

FIG. 22 is a block diagram showing components of the computer system illustrated in FIG. 21; and

FIG. 23 shows a screen shot of exemplary graphical representations of data outputted by the image processing software shown in FIG. 21 and displayed on a display device of the computer system.

### DETAILED DESCRIPTION OF EMBODIMENTS OF THE INVENTION

The description, which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

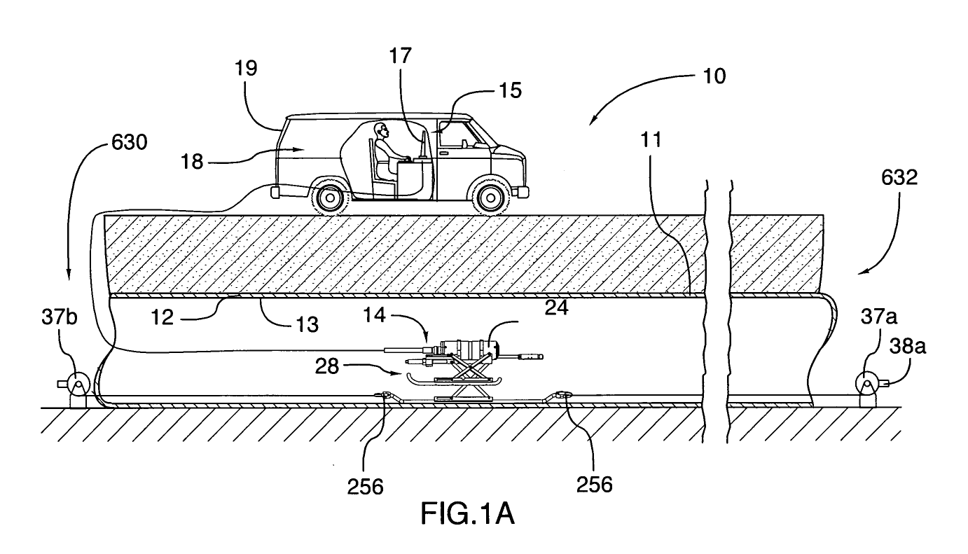

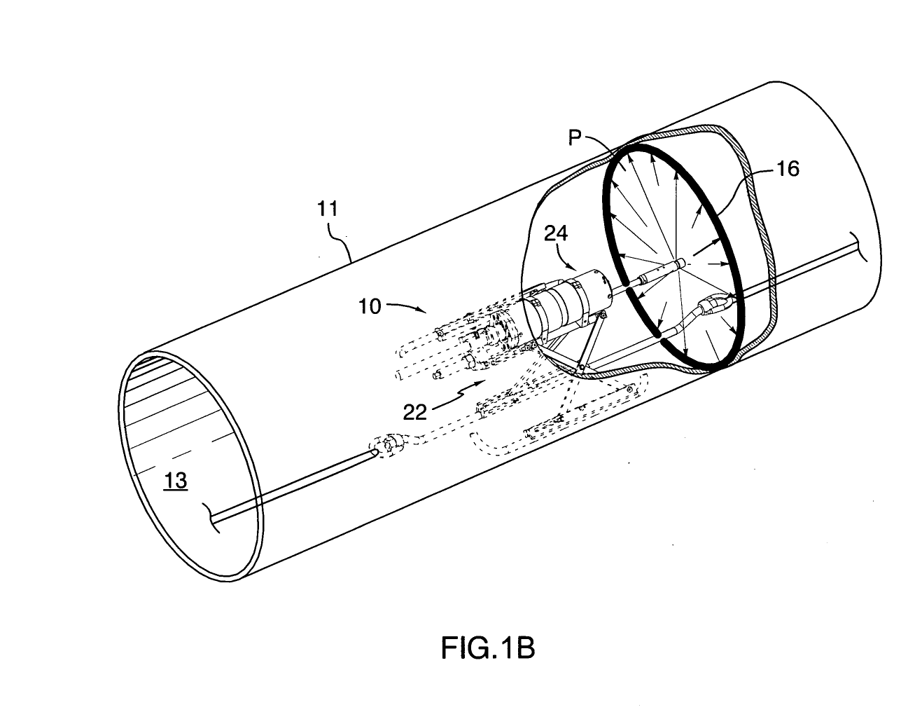

Referring to FIG. 1a, there is shown conceptually a system for scanning, mapping and measuring conduits designated generally with reference numeral 10. The system 10 is designed for deployment in a conduit 11 having a generally tubular configuration defined by a conduit wall 12 provided with an inner surface 13. In this embodiment, the conduit 11 is a municipal conduit which runs below ground and forms part of a network of water works conduits delivering potable water to residents of a neighbourhood via service connections disposed in fluid communication with the conduit 11.

Broadly speaking, the system 10 includes a data gathering or collection subsystem 14 and a data analysis or processing subsystem 15. The data collection subsystem 14 is configured for travel within conduit 11 to record images showing the profile or contour 16 of the inner conduit surface 13 outlined with a diffused laser light, and other data. The subsystem 14 uses digital video capture and laser scanning techniques to collect the images and data.

The data processing subsystem 15 is operable to process or analyze the images and data collected by the data collection system 14 using video image processing techniques, and to generate therefrom accurate 3D digital views, plans, models or maps of the conduit 11. The data processing subsystem 15 may be embodied in a computer system 17. The computer system 17 may be physically located on the work site in close proximity to the conduit being examined. For instance, it may be disposed in a control booth or center 18 located in a mobile field unit 19, as depicted in FIG. 1a. Alternatively, the computer system 17 could be located remotely from the work site.

The data collection subsystem 14 may be in real-time data communication with the data processing subsystem 15 while the data is being collected. This real-time data communication may be achieved with a wired connection (as is shown in FIG. 1a) or may be accomplished through a wireless connection. The data (image) processing operations carried out by the subsystem 15 could be performed contemporaneously or substantially contemporaneously with the data collection operations carried out by the subsystem 14. Alternatively, the data collected by the subsystem 14 could be stored in memory for later processing by the subsystem 15.

The views, plans, models or maps of the conduit 11 generated by the data processing subsystem 15 could provide or graphically show the physical dimensions of the conduit 11 (e.g. the size or diameter of the conduit) or discontinuities or irregularities in the inner surface 13 of the conduit 11 (such as cracks, or protuberances) at a particular location along its length. Additionally, particular structures of interest within the conduit (e.g. main stops, valves and hydrants) could be located on such maps, with distances and angles of orientation.

Having provided a high level overview of the conduit scanning, mapping and measuring system 10, a detailed description of each of the subsystems 14 and 15 will now be provided, starting with the data collection subsystem 14 and followed by the data processing subsystem 15. The data collection subsystem 14 includes a carriage assembly 22 and an equipment module 24 supported on the carriage assembly 22. The carriage assembly 22 has a base or cradle 28 on which is carried the equipment module 24, and a plurality of leg assemblies 30 which depend from the cradle 28. In this embodiment, the plurality of leg assemblies 30 includes a first leg assembly 32, a second leg assembly 34 and a third leg assembly 36 disposed between the first and second leg assemblies 32 and 34 in a spaced arrangement. As will be explained in greater detail below, the leg assemblies 32, 34 and 36 can be deployed in an adjustable manner to vary the height of the cradle 28 to allow it to fit within a particular conduit to be scanned and mapped, or to permit the equipment module 24 to be carried at a desired height within the conduit. In other embodiments, a greater or lesser number of leg assemblies could be employed to similar advantage.

The carriage assembly 22 is designed to be pulled, slid or dragged through the conduit 11 using front and rear motorized cable and winch arrangements 37a and 37b (shown conceptually in FIG. 1a). The front cable arrangement 37a is outfitted with an electrical counter 38 which measures out the length of cable drawn out or wound by the winch and which is in data communication with the data processing subsystem 15. In alternative embodiments, the rear cable arrangement could also be provided with an electrical counter. To move the carriage assembly 22 within the conduit 11, the front or rear cable and winch arrangement is actuated to pull the carriage assembly 22 forward or rearward.

It should be appreciated, however, that in other embodiments, with appropriate modifications, the carriage assembly could be made to be self-propelling (e.g. by providing it with a motorized drive assembly), thereby obviating the need for cable and winch arrangements.

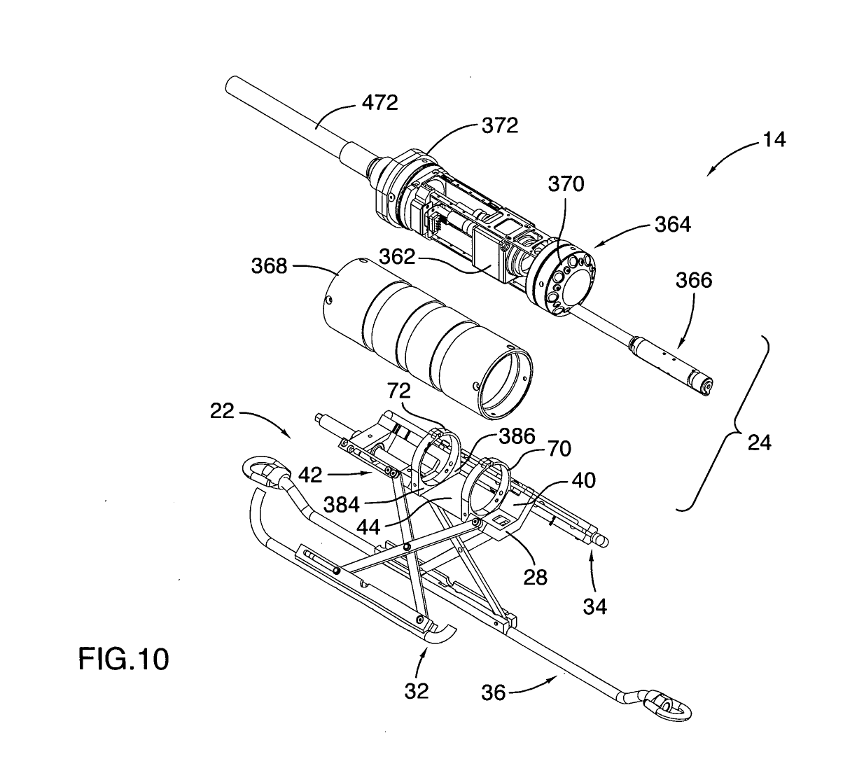

With reference to FIGS. 10 to 13, the cradle 28 is now described in greater detail. The cradle 28 includes: a relatively short, leading cradle portion 40; a relatively long, trailing cradle portion 42; and an intermediate cradle portion 44 extending between the leading cradle portion 40 and the trailing cradle portion 42 and joining the one to the other. The leading cradle portion 40 has a generally trough-like shape defined by a centrally disposed bottom wall 46 and a pair of opposed, inclined side walls 50 and 52 extending upwardly at angle from either side of the bottom wall 46. Defined in the bottom wall 46 is an aperture 54 which is sized to receive a portion of the third leg assembly 36 therethrough. As will be explained in greater detail below, a portion of the third leg assembly 36 is anchored to cradle 28 at the bottom wall 46. Similarly, the outer inclined surfaces 56 and 58 of the side walls 50 and 52 serve as anchoring sites for portions of the first and second leg assemblies 32 and 34, respectively.

The intermediate cradle portion 44 is an extension of the leading cradle portion 40, except that the intermediate cradle portion 44 is formed with a bottom wall 60 only and has no side walls corresponding to side walls 50 and 52. The bottom wall 60 runs between the leading and trailing cradle portions 40 and 42, and has an upper surface 62 and a lower surface 64. The upper surface 62 of the bottom wall 62 is substantially planar along its entire length, except at the location of two recessed stations - a first recessed station 66 and a second recessed station 68. The first recessed station 66 is disposed adjacent where the leading cradle portion 40 meets the intermediate cradle portion 44, while the second recessed station 68 is located at the juncture of the intermediate cradle portion 44 with the trailing cradle portion 42. Each station 66, 68 is configured to receive a retaining ring or collar 70, 72 that is used to secure the equipment module 24 to the cradle assembly 22.

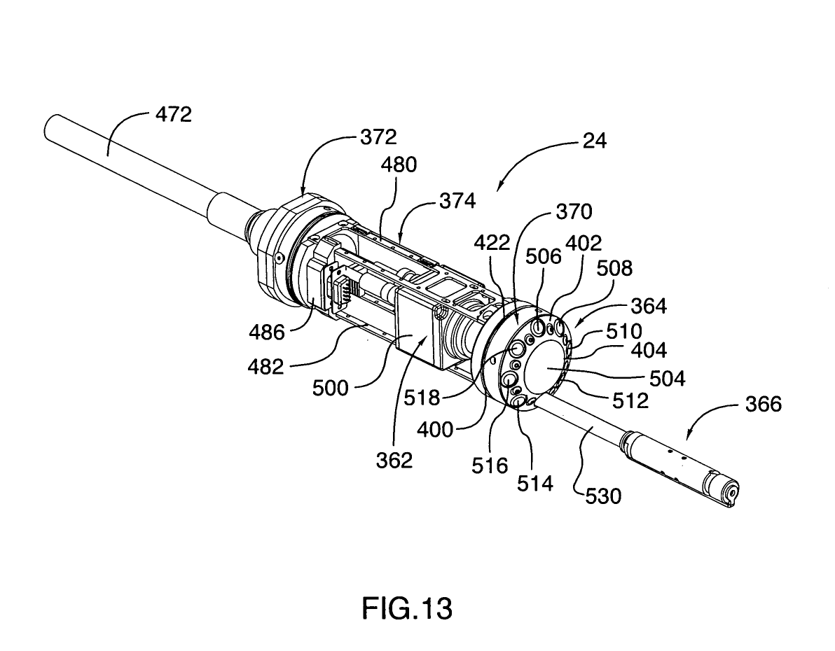

As best seen in FIG. 13, an elongate channel 74 defined centrally in the lower surface 64 of the bottom wall 60 extends along the entire length of the intermediate portion 44. The channel 74 is sized to accommodate a portion of the third leg assembly 36.

The trailing cradle portion 42 has a proximal end 76 and a distal end 78. It is an assembly made up of two spaced apart, inclined and outwardly canted arms 80 and 82 integrally formed with the intermediate cradle portion 44; a connector member 84 joining the arms 80 and 82 to each other at the distal end 78; and a slider block 86 attached to each of the connector member 84 and the arms 80 and 82 and capable of being displaced along a linear path between the proximal end 76 and distal end 78. The shape of the trailing cradle portion 42 is trough-like not unlike the leading cradle portion 40, except that the trailing cradle portion 42 is formed without a continuous bottom wall, and the side walls have been replaced with somewhat shallower arms 80 and 82. In place of where the bottom wall and side walls would have been, there is a space 88 bounded at the distal end 78 by the connector member 84. The space 88 accommodates the slider block 86.

Each arm 80, 82 has an upper surface 92, a lower surface 94 and an elongate guide slot 96 extending between the upper and lower surfaces 92 and 94. Each guide slot 96 is configured to receive a pair of connector pins 98 and 100 that are attached to the slider block 86. Together with the guide slots 96 and the lower surfaces 94 of the arms 80 and 82, the connector pins 98 and 100 serve to constrain movement of the slider block 86 along a substantially horizontal path within the space 88. The connectors 98 also serve to attach portions of the first leg assembly 32 and the second leg assembly 34 to the slider block 86.

Adjacent the distal end 78, each arm 80, 82 has two bores 102 and 104 defined that extend through the upper and lower surfaces 92 and 94. The bores 102 and 104 accommodate fasteners (not visible) that are used to attach the connector member 84 to the arms 80 and 82.

The connector member 84 has a centrally disposed, relatively thick, bottom wall 106 and a pair of opposed, and inclined side walls 108 and 110 extending upwardly at angle from either side of the bottom wall 106. The connector member 84 and the arms 80 and 82 are fixed to each other with the end surface of side wall 108, 110 bearing against the lower surface 94 of arm 80, 82, respectively. Bores (not shown) formed into the end surfaces of the side walls 108 and 110, align with bores 102 and 104 to receive the fasteners attaching the connector member 84 to the arms 80 and 82.

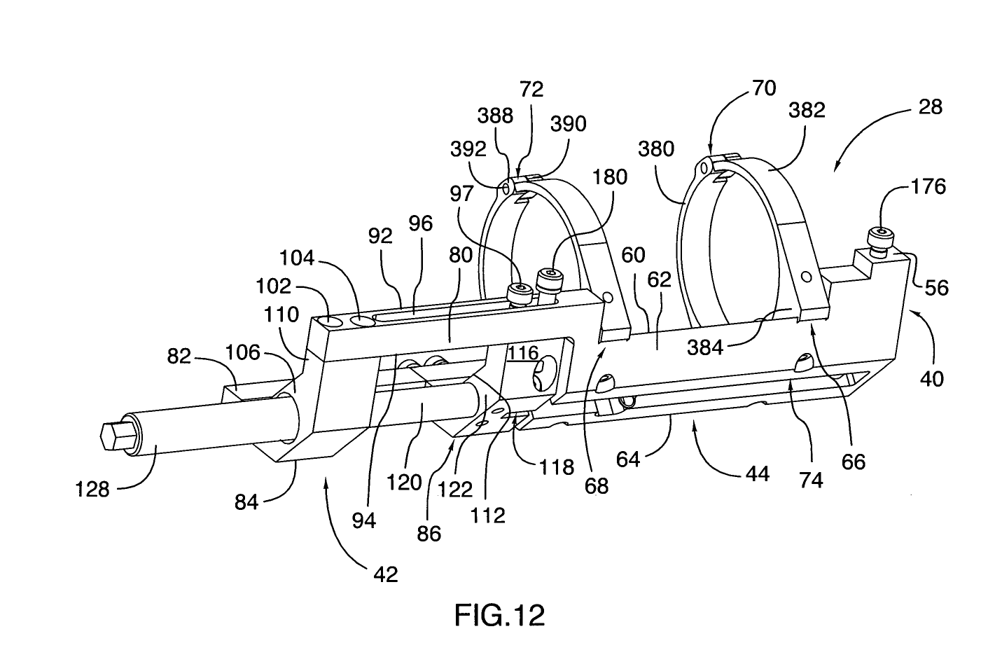

The slider block 86 resembles the connector member 84 in that it too has a centrally disposed, relatively thick, bottom wall 112 and a pair of opposed, inclined side walls 114 and 116 extending upwardly at angle from either side of the bottom wall 112. As best shown in FIGS. 12 and 13, a vertical cutout 118 is provided in the bottom wall 112. The vertical cutout 118 is sized to accommodate a portion of the third leg assembly 36. The slider block 86 is arranged relative to the arms 80 and 82 in such a manner that the side walls 114 and 116 are aligned with the guide slots 96 formed in the arms 80 and 82 with the end surfaces of the side walls 114 and 116 bear against the lower surfaces 94 of the arms 80 and 82, respectively. Bores (not shown) formed into the end surfaces of the side walls 114 and 116, are configured to receive the connectors pins 98 and 110 which extend through the guide slots 96.

Connecting the slider block 86 to the connector member 84 is a large threaded bolt 120. The bolt 120 is fixed at one end to the slider block 86. It extends from the trailing face 122 of the bottom wall 112 through a threaded bore (not visible) formed in the leading face 124 of the bottom wall 108 and ultimately protrudes from the trailing face 126 of the bottom wall 108. A large nut 128 is fastened to the protruding end of the bolt 120. The connector member 84, the slider block 86, the bolt 120 and the nut 128 cooperate with each other to define a screw thread mechanism 130 which may be actuated to displace the slider block 86 within the space 88. Tightening the nut 128 causes the bolt 120 (and the slider block 86 fixed thereto) to migrate toward the trailing direction. Conversely, loosening the nut 128, urges the bolt 120 (and the slider block 86) to advance in the opposite direction. As will be explained in greater detail below, the screw thread mechanism 130 in conjunction with the first, second and third leg assemblies 32, 34 and 36 is operable to raise or lower the carriage assembly 22 in order to size the data collection subsystem 14 to fit within a particular conduit.

In this embodiment, the cradle 28 is made of stainless steel. In other embodiment, the cradle could be fabricated from other materials selected for their strength and corrosion resistance characteristics.

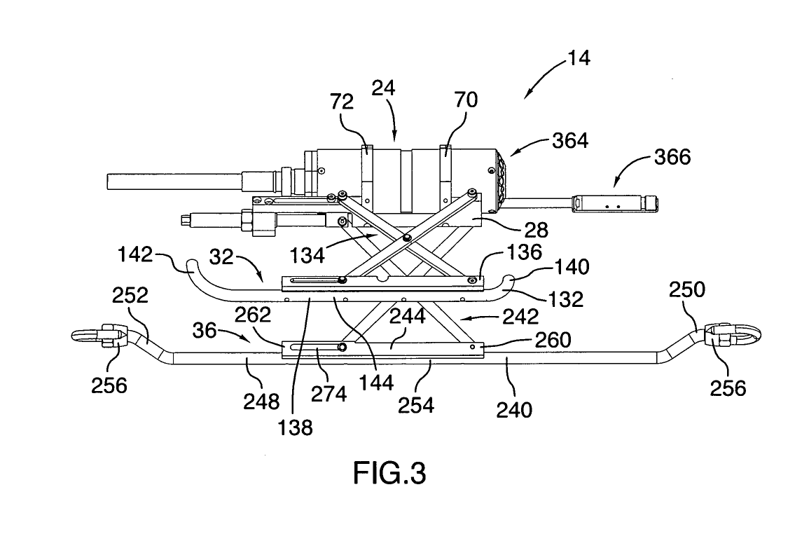

In other embodiments, the cradle could be configured differently. For example, in the embodiment shown in FIG. 3, a portion of the equipment module 24 (the laser beam emitting and diffusing system 366) extends beyond the leading cradle portion 40 and remains unsupported. In other embodiments, the leading cradle portion could be extended so as to provide support for the equipment module along its entire length. The cradle could be modified in other ways as well.

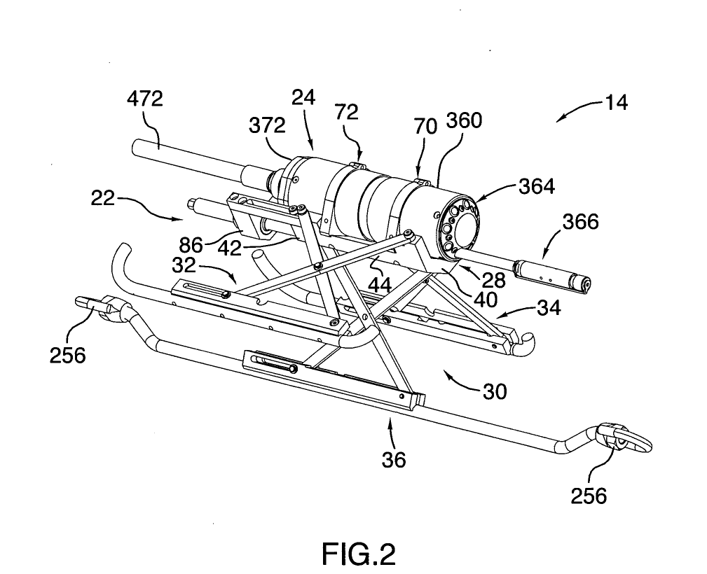

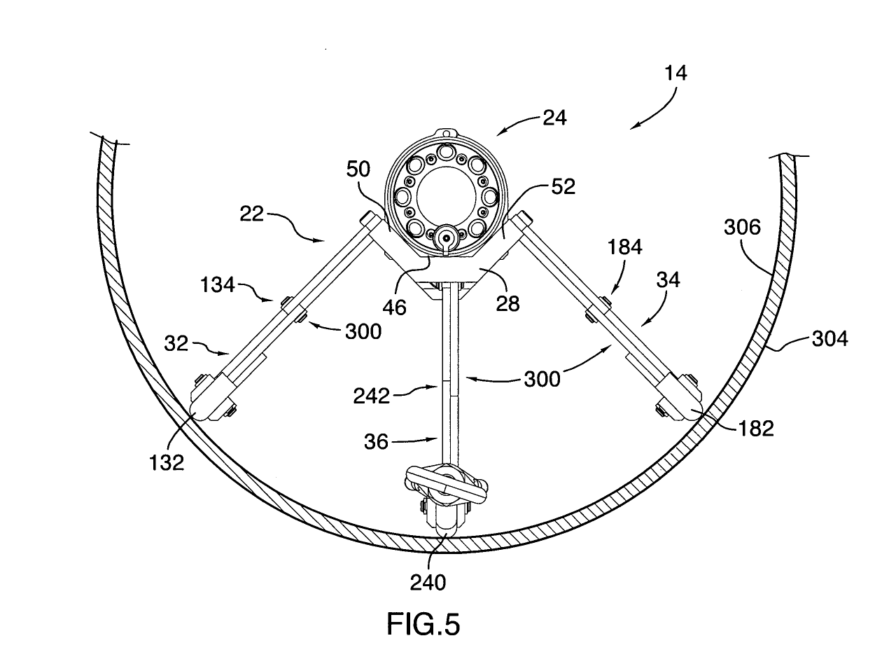

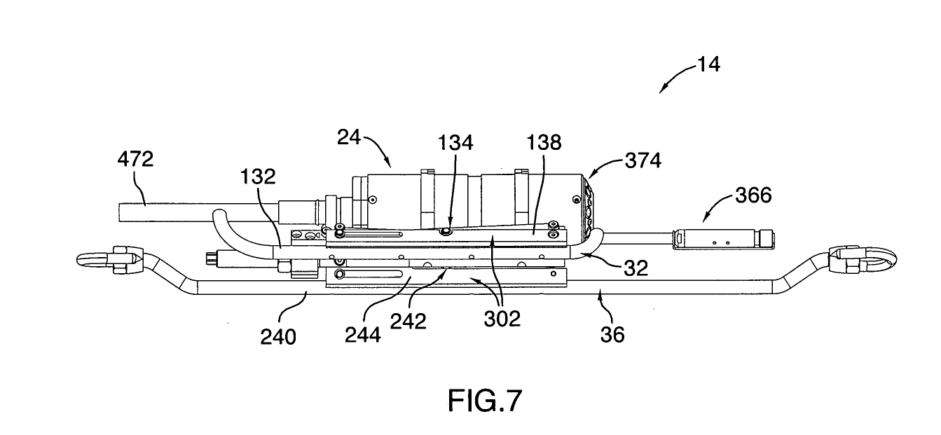

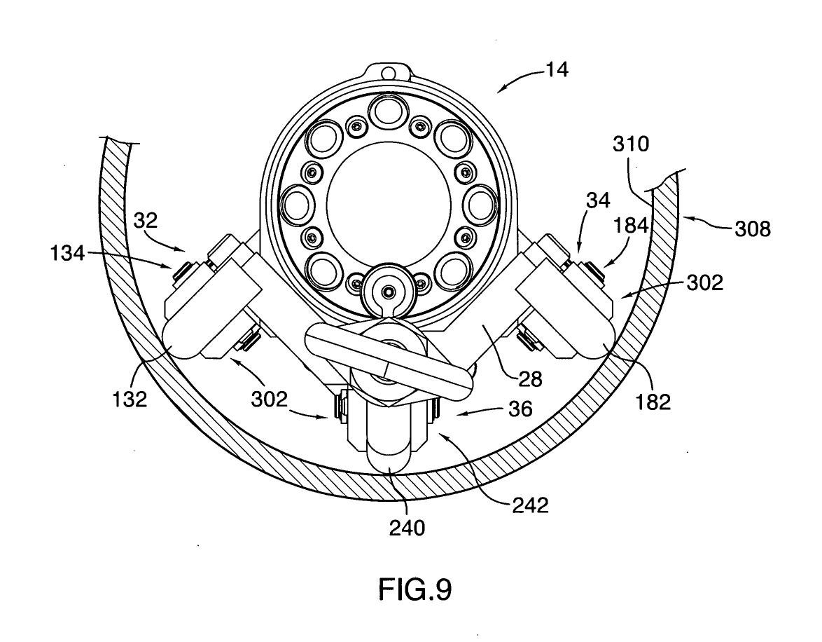

Turning now to FIGS. 2 to 9, the arrangement of the first, second and third leg assemblies 32, 34 and 36 will now be described in greater detail. The third leg assembly 36 extends downwardly from the cradle 28 in a vertical orientation and is disposed between the first and second leg assemblies 32 and 34. The first leg assembly 32 is radially spaced from the third leg assembly 36 by an angle of 45 degrees extending in a counter-clockwise direction. Similarly, the second leg assembly 34 is radially spaced from the third leg assembly 36 by an angle of 45 degrees extending in the clockwise direction (see FIGS. 5 and 9).

When the carriage assembly 22 is deployed within a conduit, the first, second and third leg assemblies 32, 34 and 36 work together to stabilize the cradle 28 and maintain it at a desired attitude within the conduit. This particular arrangement tends to be well-suited for deployment in conduits having circular or substantially circular cross-sections. In other embodiments, it will be appreciated that the leg assemblies could be disposed differently (i.e. with different radial spacing). Conceivably, with appropriate modifications to the leg assemblies, an alternate data collection subsystem could be used in conduits having different cross-sections, for example, oval or substantially oval cross-sections.

As shown in FIGS. 2, 3, and 4, the first leg assembly 32 has a runner member 132, a scissor-leg arrangement 134, and a longitudinal bracket member 136 for attaching the runner member 132 to the scissor-leg arrangement 134. The runner member 132 is configured to bear against the inner curved surface of the conduit 11. It includes a tubular body 138 which has an upturned leading portion 140, an upturned trailing portion 142 and an intermediate body portion 144 that extends between the leading and trailing portions 140 and 142. The bracket member 136 is fastened to the intermediate body portion 144 at several locations.

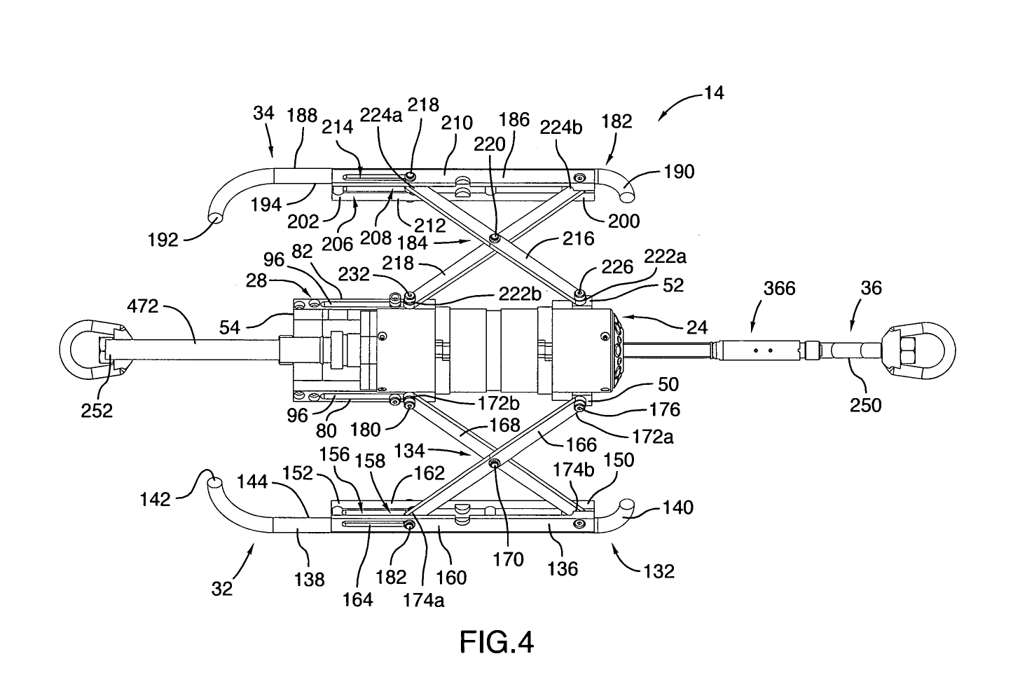

Referring specifically to FIGS. 2 and 4, the bracket member 136 can be seen to have a leading end 150, a trailing end 152, a lower surface 154 and an upper surface 156. The lower surface 154 of the bracket member 136 is curved to conform generally to the curvature of the intermediate body portion 144 to facilitate attachment thereto. A longitudinal track 158 cuts deeply into the upper surface 156 extending nearly to the lower surface 154. The track 158 runs from the leading end 150 to the trailing end 152 and defines two opposed side portions 160 and 162 of the bracket member 136. Each side portion 160, 162 has an elongate slot 164 defined therein adjacent the trailing end 152 of the bracket member 136.

The scissor-leg arrangement 134 includes a pair of first and second scissor legs 166 and 168 pivotally connected to each other at their respective midpoints by a pin 170. Each scissor leg 166, 168 has an apertured upper end 172a, 172b, respectively, for pivotally connecting to the cradle 28 and an apertured lower end 174a, 174b, respectively, for pivotal attachment to the bracket member 136. The upper end 172a of the first scissor leg 166 is pivotally connected to the side wall 50 of the leading cradle portion 40 by a pivot pin 176 extending through the upper end 172a and into the outer inclined surface 56 of the side wall 50. The lower end 174a of the first scissor leg 166 is received within the track 154 formed in the bracket member 136. A pin 178 captively retained by the slots 164 formed in the side portions 160 and 162, pivotally connects the lower end 174a to the bracket member 136. This arrangement constrains the lower end 174a of the first scissor leg 166 to travel within the slots 164.

The upper end 172b of the second scissor leg 168 is pivotally connected to the slider block 86 by a pivot pin 180 extending through the upper end 172b and the guide slot 96 formed in the arm 80, and into the end surface of the side wall 114. The lower end 174b of the second scissor leg 168 is received within the track 158 formed in the bracket member 136 and is retained in place by a pin 182 extending through the side portion 160, the lower end 174b and the side portion 162.

As best shown in FIGS. 3 and 4, the second leg assembly 34 is disposed in a mirror image arrangement of the first leg assembly 32. Moreover, the second leg assembly 34 is similar to the first leg assembly 32 in that it too possesses a runner member 182, a scissor-leg arrangement 184, and a longitudinal bracket member 186 for attaching the runner member 182 to the scissor-leg arrangement 184. In like fashion to the runner member 132, the runner member 182 is configured to bear against the inner curved surface of a conduit. It includes a tubular body 188 which has an upturned leading portion 190, an upturned trailing portion 192 and an intermediate body portion 194 that extends between the leading and trailing portions 190 and 192. The bracket member 186 is fastened to the intermediate body portion 194 at several locations.

Referring specifically to FIGS. 2 and 4, the bracket member 186 can be seen to have a leading end 200, a trailing end 202, a lower surface 204 and an upper surface 206. The lower surface 204 of the bracket member 186 is curved to conform generally to the curvature of the intermediate body portion 194 to facilitate attachment thereto. A longitudinal track 208 cuts deeply into the upper surface 206 extending nearly to the lower surface 204. The track 208 runs from the leading end 200 to the trailing end 202 and defines two opposed side portions 210 and 212 of the bracket member 186. Each side portion 210, 212 has an elongate slot 214 defined therein adjacent the trailing end 202 of the bracket member 186.

The scissor-leg arrangement 184 includes a pair of first and second scissor legs 216 and 218 pivotally connected to each other at their respective midpoints by a pin 220. Each scissor leg 216, 218 has an apertured upper end 222a, 222b, respectively, for pivotally connecting to the cradle 28 and an apertured lower end 224a, 224b, respectively, for pivotal attachment to the bracket member 186. The upper end 222a of the first scissor leg 216 is pivotally connected to the side wall 52 of the leading cradle portion 40 by a pivot pin 226 extending through the upper end 222a and into the outer inclined surface 58 of the side wall 52. The lower end 224a of the first scissor leg 216 is received within the track 208 formed in the bracket member 186. A pin 228 captively retained by the slots 214 formed in the side portions 210 and 212, pivotally connects the lower end 224a to the bracket member 186. This arrangement constrains the lower end 224a of the first scissor leg 216 to travel within the slots 214.

The upper end 222b of the second scissor leg 218 is pivotally connected to the slider block 86 by a pivot pin 230 extending through the upper end 222b and the guide slot 96 formed in the arm 82, and into the end surface of the side wall 116. The lower end 224b of the second scissor leg 218 is received within the track 204 formed in the bracket member 186 and is retained in place by a pin 232 extending through the side portion 210, the lower end 224b and the side portion 212.

Referring now to FIGS. 2, 3 and 5, the third leg assembly 36 is similar to the first and second leg assemblies 32 and 34 in that it too possesses a runner member 240, a scissor-leg arrangement 242, and a longitudinal bracket member 244 for attaching the runner member 240 to the scissor-leg arrangement 242. The runner member 240 is configured to bear against the inner curved surface of a conduit. It includes a tubular body 248 which has an upturned leading portion 250, an upturned trailing portion 252 and an intermediate body portion 254 that extends between the leading and trailing portions 250 and 252. Each of the portions 250, 252 includes a lug 256 to which may be tethered a cable, wire or rope to facilitate sliding/dragging of the carriage assembly 22 within the conduit.

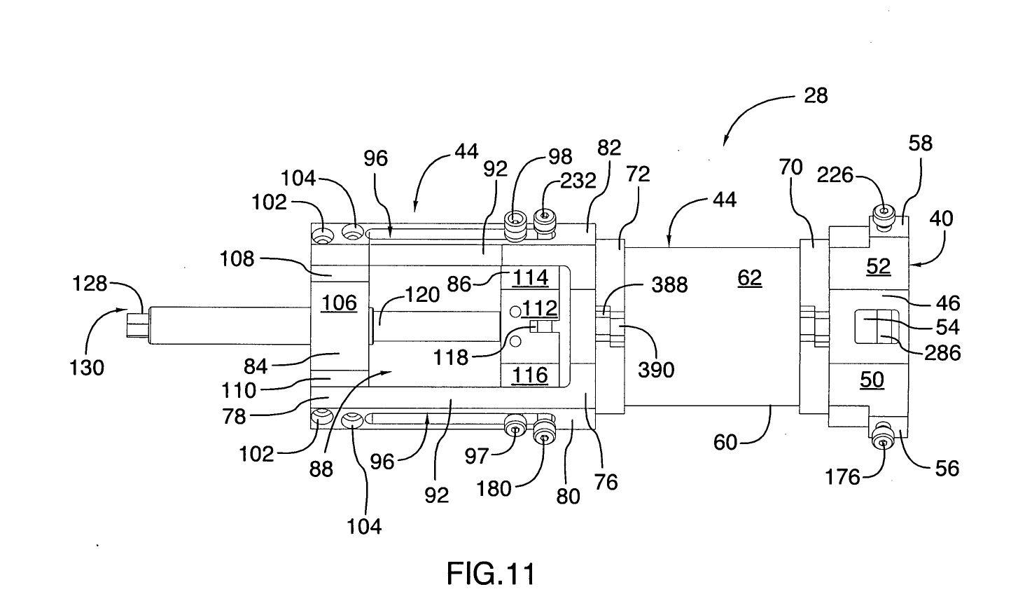

Referring specifically to FIGS. 2 and 11, the bracket member 244 is fastened to the intermediate body portion 254 at several locations. The bracket member 244 can be seen to have a leading end 260, a trailing end 262, a lower surface 264 and an upper surface 266. The lower surface 264 of the bracket member 244 is curved to conform generally to the curvature of the intermediate body portion 254 to facilitate attachment thereto. A longitudinal track 268 cuts deeply into the upper surface 266 extending nearly to the lower surface 264. The track 268 runs from the leading end 260 to the trailing end 262 and defines two opposed side portions 270 and 272 of the bracket member 244. Each side portion 270, 272 has an elongate slot 274 defined therein adjacent the trailing end 262 of the bracket member 244.

The scissor-leg arrangement 242 includes a pair of first and second scissor legs 276 and 278 pivotally connected to each other at their respective midpoints by a pin 280. Each scissor leg 276, 278 has an apertured upper end 282a, 282b, respectively, for pivotally connecting to the cradle 28 and an apertured lower end 284a, 284b, respectively, for pivotal attachment to the bracket member 244. The upper end 282a of the first scissor leg 276 is received within the aperture 54 defined in the bottom wall 46 of the leading cradle portion 40 and pivotally connected to the bottom wall 46 by a pivot pin 286 (visible in FIG. 11).

The lower end 284a of the first scissor leg 276 is received within the track 268 formed in the bracket member 244. A pin 288 captively retained by the slots 274 formed in the side portions 270 and 272, pivotally connects the lower end 284a to the bracket member 244. This arrangement constrains the lower end 284a of the first scissor leg 276 to travel within the slots 274.

The upper end 282b of the second scissor leg 278 is received into the vertical cutout 118 defined in the bottom wall 112 of the slider block 86. A pivot pin 290 (visible in FIG. 3) pivotally connects the upper end 282b to the slider block 86. The lower end 284b of the second scissor leg 278 is received within the track 268 formed in the bracket member 244 and is retained in place by a pin 292 extending through the side portion 270, the lower end 284b and the side portion 272.

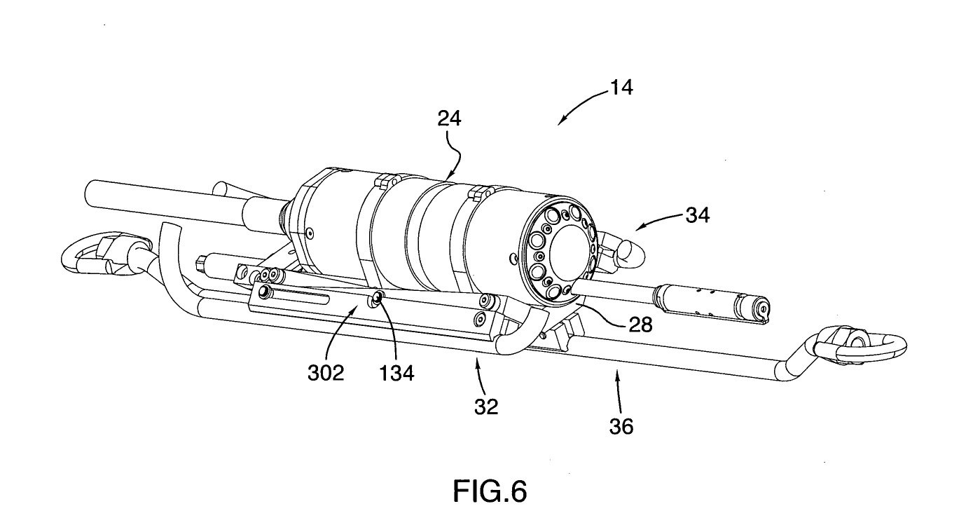

Having described the components of each of the leg assemblies 32, 34 and 36, the functionality of these assemblies will now be explained in greater. Each of the leg assemblies 32, 34, 36 is movable between a fully extended position 300 (shown in FIGS. 2 to 5) and a fully retracted position 302 (shown in FIGS. 6 to 9). When the leg assemblies 32, 34 and 36 are in their respective fully extended positions 300, the data collection subsystem 14 tends to be well-suited for deployment in large diameter conduits, such as conduit 304 shown in FIG. 5. The scissor-leg arrangements 134, 184 and 242 are opened to the fullest extent their configuration will allow, and the carriage 28 is lifted to its greatest height above the inner surface 306 of the conduit 304. As shown in FIG. 4, in the case of the first scissor-leg assembly 134, the upper end 172b of the second scissor leg 168 is located at the leading end of the guide slot 96 formed in the arm 80 and the lower end 174a of the first scissor leg 166 is located at the leading end of the slots 164 formed in the side portions 160 and 162. In like fashion, in the case of the second scissor-leg assembly 184, the upper end 222b of the second scissor leg 218 is located at the leading end of the guide slot 96 formed in the arm 82 and the lower end 224a of the first scissor leg 216 is located at the leading end of the slots 214 formed in the side portions 210 and 212. The sliding block 86 is closest to the proximal end 76 of the trailing cradle portion 42 when the leg assemblies 32, 34 and 36 are in their respective fully extended positions 300. In the case of the third scissor-leg arrangement 242, the lower end 284a of the first scissor leg 276 is located at the leading end of the slots 274 formed in the side portions 270 and 272.

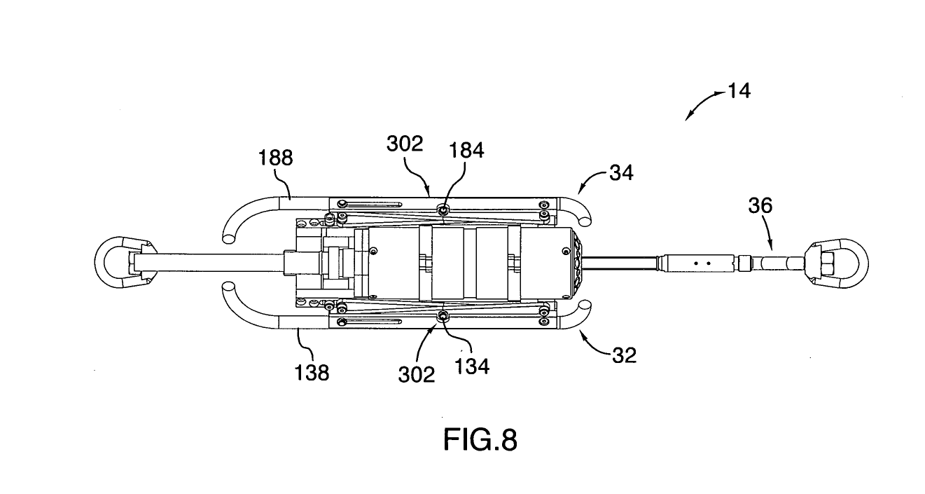

When the leg assemblies 32, 34 and 36 are in their respective fully retracted positions 302, the data collection subsystem 14 tends to be well-suited for deployment in small diameter conduits, such as conduit 308 shown in FIG. 9. The scissor-leg arrangements 134, 184 and 242 are collapsed to the fullest their configuration will allow, and the cradle 28 is carried to its smallest height above the inner surface 310 of the conduit 308. As shown in FIG. 8, in the case of the first scissor-leg assembly 134, the upper end 172b of the second scissor leg 168 is located adjacent the trailing end of the guide slot 96 formed in the arm 80 and the lower end 174a of the first scissor leg 166 is located at the trailing end of the slots 164 formed in the side portions 160 and 162. In like fashion, in the case of the second scissor-leg assembly 184, the upper end 222b of the second scissor leg 218 is located adjacent the trailing end of the guide slot 96 formed in the arm 82 and the lower end 224a of the first scissor leg 216 is located at the trailing end of the slots 214 formed in the side portions 210 and 212. The sliding block 86 is closest to the distal end 78 of the trailing cradle portion 42 when the leg assemblies 32, 34 and 36 are in their respective fully retracted positions 302. In the case of the third scissor-leg arrangement 242, the lower end 284a of the first scissor leg 276 is located at the trailing end of the slots 274 formed in the side portions 270 and 272.

Moving the leg assemblies 32, 34 and 36 between the fully extended position 300 and the fully retracted position 302 can be accomplished relatively easily by either tightening or loosening the nut 128 in the screw thread mechanism 130 with the use of a tool. Tightening the nut 128 on the bolt 120 will cause the slider block 86 to migrate toward the distal end 78 of the trailing cradle portion 42, thereby shortening the scissor leg arrangements 134, 184 and 242 and lowering the height of cradle 28. Conversely, loosening the nut 128 from the bolt 120 will cause the slider block 86 to migrate toward the proximal end 76 of the trailing cradle portion 42, thereby lengthening the scissor leg arrangements 134, 184 and 242 and raising the height of cradle 28.

The provision of adjustable leg assemblies 32, 34 and 36 tends to enhance the versatility of the data collection subsystem 14, as it enables the subsystem 14 to be selectively configured or sized to fit within conduits of varying diameter. This tends to obviate the need to have different-sized carriage assemblies for different-sized conduits. In this embodiment, the subsystem 14 can be configured to travel in conduits ranging in size between 6 in. (the diameter of conduit 310) and 14 in. (the diameter of conduit 306). In other embodiments, the range of conduit sizes could be different.

In this embodiment, the adjustability of the leg assemblies 32, 34 and 36 is made possible by the mechanical scissor-leg arrangement of each leg assembly 32, 34, 36 and the screw thread mechanism 130. In other embodiments, it may be possible to replace the screw thread mechanism in favour of pneumatic or hydraulic cylinders operatively connected to the scissor-leg arrangements of the leg assemblies to extend or retract the leg assemblies. In yet other embodiments, the scissor-leg arrangements of each leg assembly could be include a re-circulating screw arrangement which may be driven by a motor. However, it will be appreciated that in alternative embodiments the adjustability of the leg assemblies could be achieved using different arrangements. For instance, in a different embodiment, the leg assemblies could be fabricated with telescoping portions which could be extended or retracted to adjust the height of leg assemblies (and the cradle). In other embodiments, the leg assemblies could be provided with pneumatic or hydraulic cylinders which could be actuated to retract or extend in such a manner as to act on portions of the leg assemblies to adjust the height at which the cradle is carried within the conduit. In further alternative embodiments, other vertical displacement mechanisms could be employed.

In still other embodiments, the cradle assembly could be configured with non-adjustable leg assemblies. In such embodiments, the height at which the cradle would be carried above the inner surface of the conduit would remain constant.

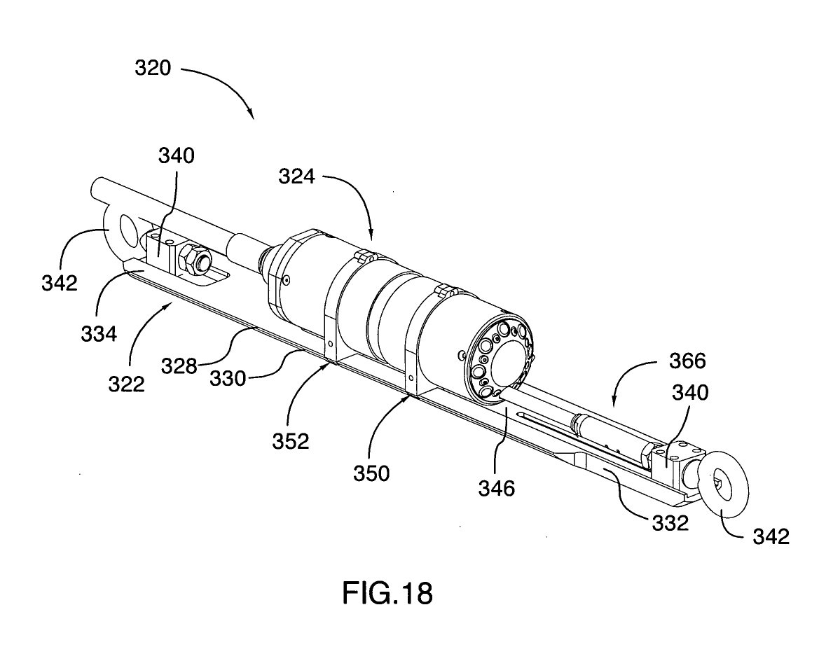

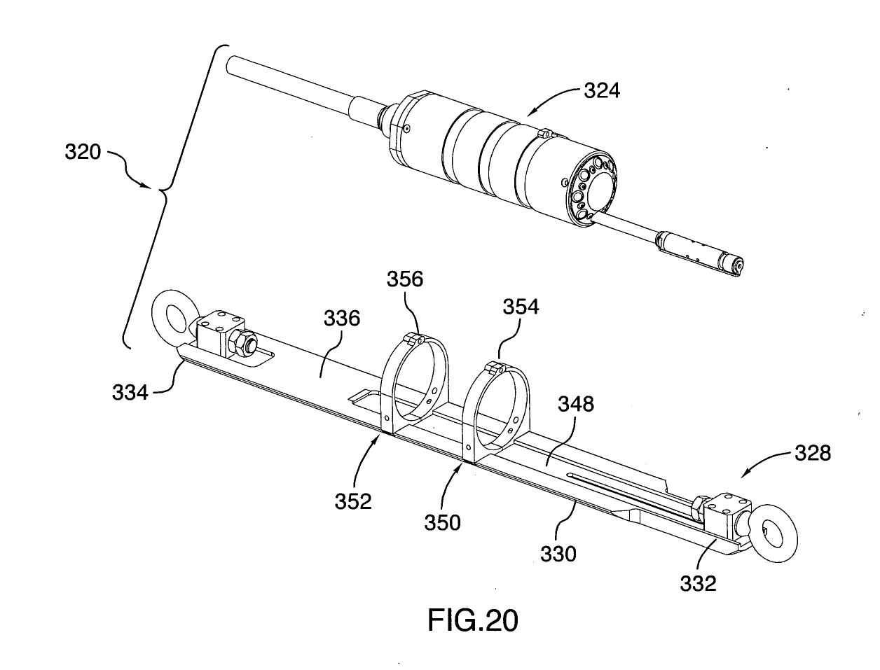

For certain applications (for instance, where tight space restrictions exist), it may be desirable to design the cradle assembly without any leg assemblies at all in order to make the conduit scanning, mapping and measuring system more compact. An example of one such embodiment is shown in FIGS. 18, 19 and 20, wherein an alternate data collection subsystem is designated generally with reference numeral 320. The subsystem 320 resembles the subsystem 14 in that it too possesses a carriage assembly 322 and an equipment module 324 supported on the carriage assembly 320. The equipment module 324 is similar to the equipment module 22 of subsystem 14 in all material respects (i.e. structure, components and functionality). The carriage assembly 322 has a base or cradle 328. But in contrast to the carriage assembly 22 of subsystem 14, the carriage assembly 322 has no leg assemblies.

In this embodiment, the cradle 328 has a narrow sled-like body 330 with a leading end 332, a trailing end 334, a top side 336 and an underside 338. Fastened at either end 332 and 334 of the body 330 is a mounting block 340 for retaining a lug 342. A cable, wire or rope may be tied to the lug 342 to facilitate sliding/dragging of the carriage assembly 322 within the conduit. The width of the body 330 is narrowest at the leading end 332, but increases at a location roughly one fifth of the way to the trailing end 334, remaining constant thereafter until the trailing end 334.

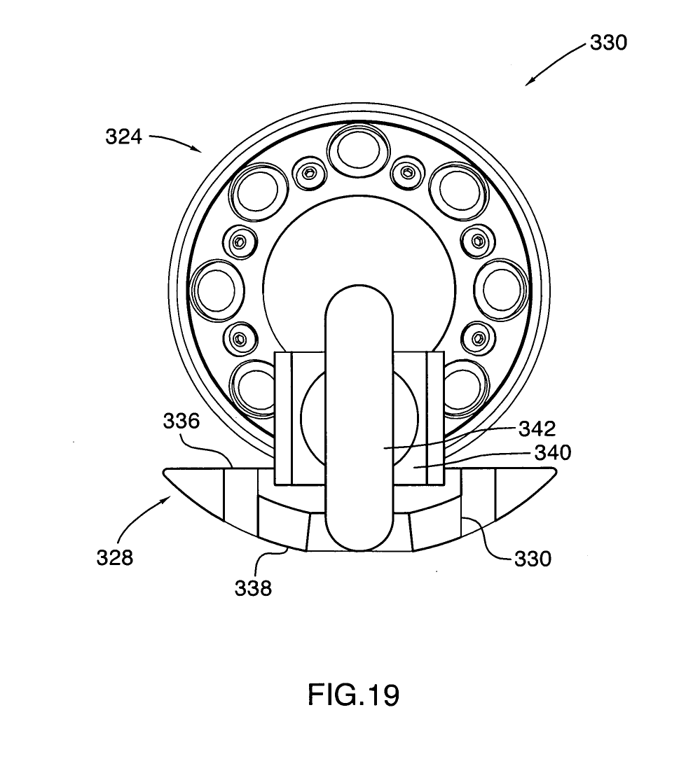

The underside 338 of the cradle body 330 is curved to enhance the stability of the cradle assembly 322 when it bears against the inner surface 344 of a small-diameter conduit 346 (see FIG. 19). The top side 336 of the cradle body 330 has a central indent 348 which is provided to accommodate portions of the equipment module 324. The top side 336 also includes two recessed stations—a first recessed station 350 and a second recessed station 352. The first recessed station 350 is disposed closer to the leading end 332, while the second recessed station 352 is arranged closer to the trailing end 334. Each station 350, 352 is configured to receive retaining rings or collars 354, 356 (not unlike retaining collars 70 and 72) for securing the equipment module 324 to the cradle assembly 322.

In contrast to the cradle 28 of the subsystem 14 which left some portions of the equipment module 24 unsupported, the cradle 328 supports the equipment module 324 along its entire length. More specifically, the laser beam emitting and diffusing system of the equipment module 324 is supported by the cradle body 330 within the central indent 348.

In this embodiment, the cradle 328 is made of stainless steel. In other embodiment, the cradle could be fabricated from other materials selected for their strength and corrosion resistance characteristics.

FIG. 19 shows the subsystem 320 deployed in the small diameter conduit 346. In this embodiment, the small diameter of the conduit 346 ranges between 4 inches and 6 inches. In other embodiments, the subsystem 320 could be deployed in other conduits of varying size.

With reference to FIGS. 10 and 13 to 17, the description now turns to the equipment module 24. The relatively compact equipment module 24 includes a housing 360 and various components contained therein, namely, a video capture system 362 and a lighting assembly 364. The housing 360 protects the components from impact and exposure to extreme temperatures, humidity, dust, sand etc. It has a tubular casing 368 that is sealed or closed off at one end by a front cover assembly 370, and at the other end by a rear cover assembly 372. Mounted within the housing 360 is an internal frame 374 which supports the video capture system 362.

In other embodiments, the equipment module 24 could include additional components for enhanced functionality. For instance, an inertial navigation system (or other integrated coordinate recording device) possessing an array of accelerometers, gyroscopes, or other motion-sensing devices and configured for data communication with the data processing subsystem 14, could be provided. This inertial navigation system could be configured to record the travel trajectory of the data collection subsystem and calculate the position and orientation of the data collection subsystem within the conduit, as well as the location and orientation of any physical features in the conduit (e.g. water services, valves, hydrants and the like). The location and orientation of these features of interest could be correlated to externally obtained GPS coordinates in order to yield exact locations for such features expressed in a recognized coordinate system (i.e. GPS). Advantageously, this functionality would permit municipalities, maintenance departments, builders and other parties involved in the design, construction, maintenance and repair of conduit infrastructure, to locate features of interest within a specified accuracy without having to directly access the inspected pipeline.

In an alternative embodiment, the equipment module 24 could further include a data processing subsystem or components thereof to facilitate the overlay of various data, accommodated within the housing.

In this embodiment, the equipment module 24 receives power through lines (not shown) running from the mobile field unit 19. In other embodiments, the components of the equipment module could be powered using alternate power sources (for example, battery packs).

The casing 368 is robust, water-resistant, and made of stainless steel. The casing 368 (and the equipment module 24) are fixedly retained on the cradle 28 by first and second retaining collars 70 and 72. Referring to FIGS. 10 and 12, each retaining collar 70, 72 is defined by a pair of substantially semi-circular, half collar portions 380 and 382 mounted in opposition one to the other. The lower end of each half collar portion 380, 382 is formed with a base 384, 386 which is configured for location in the station 66, 68 (as the case may be) and for attachment to the intermediate cradle portion 42. The upper ends of the half collar portions 380 and 382 terminate with apertured fittings 388 and 390. The apertures formed in the fittings 388 and 390 may be aligned to allow for the insertion therethrough of a locking pin 392. With the locking pin 392 in place, the half collar portions 380 and 382 surround and tightly retain the casing 368 thereby preventing it from accidentally becoming detached from the cradle 28. In other embodiments, alternate retaining means may be used to secure the casing (and the equipment module) to the cradle.

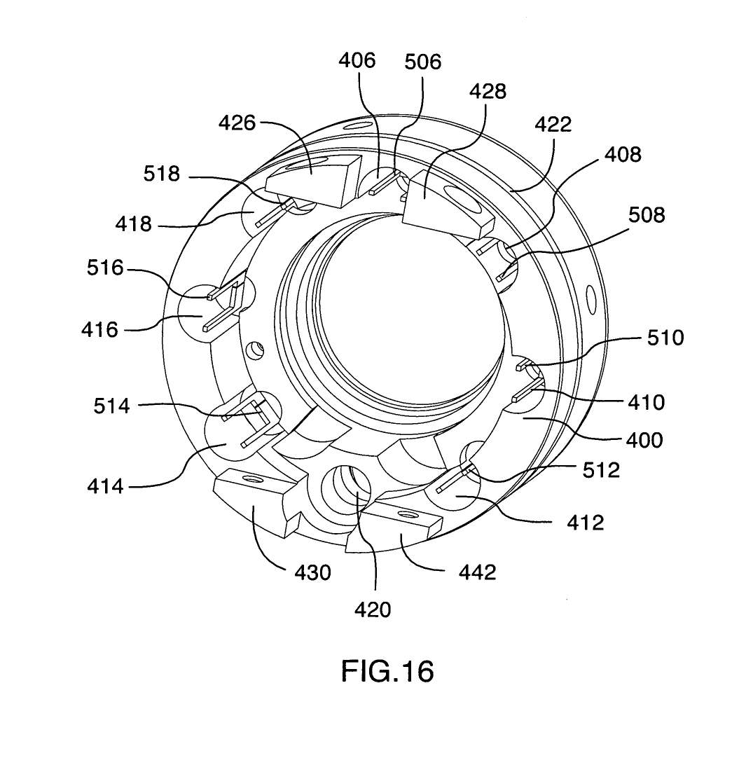

The front cover assembly 370 can be seen to have a generally circular body 400 and a protective plate 402 secured to the front of the body 400. As best shown in FIG. 16, the body 400 has defined therein a relatively large, centrally disposed aperture 404 and a plurality of smaller sockets 406, 408, 410, 412, 414, 416, 418 and 420 disposed in a spaced apart fashion around the large aperture 404. In other embodiments, the body could be shaped differently and/or formed with a greater or lesser number of sockets laid out in a different manner. The large aperture 404 is sized to receive therethrough a portion of the video capture system 362, whereas the sockets 406, 408, 410, 412, 414, 416 and 418 are designed to accommodate portions of the lighting assembly 364. Socket 420 is threaded and serves as the connection site for attaching a laser beam emitting and diffusion assembly 366 to the front cover assembly 370.

Still referring to FIG. 16, a circumferential groove 422 formed at a location roughly midway between the front and rear of the body 400 defines a seat for locating a seal (not shown) to be retained between the body 400 and the casing 368. This seal discourages dust, moisture, sand or grit from penetrating into the interior space of the housing 360 and possibly interfering with the proper operation of the video capture system 362. Protruding rearward from the rear of the body 400 is a first pair of mounting tabs 426 and 428 disposed adjacent to each other, a second pair of mounting tabs 430 and 432 disposed adjacent to each other, but arranged in opposition to the first pair of mounting tabs 426 and 428. The mounting tabs 426, 428, 430 and 432 serve to attach the internal frame 374 to the front cover assembly 370.

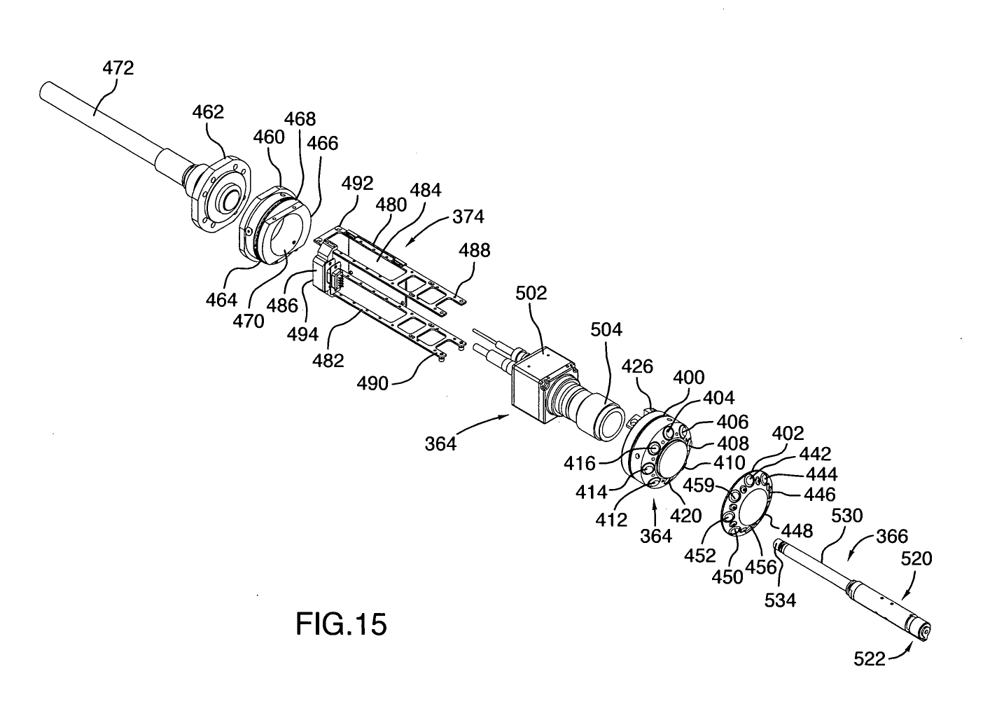

As shown in FIG. 15, the protective plate 402 is also formed with a large central aperture 440 and eight smaller sockets 442, 444, 446, 448, 450, 452, 454 and 456 which align with aperture 404 and the sockets 406, 408, 410, 412, 414, 416, 418 and 420, respectively, when the protective plate 402 is fastened to the body 400.

The rear cover assembly 372 includes an apertured sleeve-like member 460 and an annular end plate 462 threadlingly fastened to the sleeve-like member 460. The sleeve-like body 460 has a seat 464 defined therein for locating a seal (not shown) to be retained between the casing 368 and the rear cover assembly 372 to keep dust, moisture, sand or grit out of the interior space of the housing 360. Disposed in front of the seat 464 is a flange 466 whose outer surface has been partially truncated to create two opposing planar ledges 468 and 470 (see FIG. 15). The ledges 468 and 470 serve as connection sites for attaching the internal frame 374 to the rear cover assembly 372.

Captively retained between the annular end plate 462 and the sleeve-like member 460 is the end of a 12-pin connector 472 which is used to transmit the data recorded by the video capture system 362 to the computer system 17. In embodiments where such data transmission is effected wirelessly, the annular end plate and 12-pin connector could be omitted.

The internal frame 374 is made up of two spaced apart open web members 480 and 482, a plate 484 which spans between the web members 480 and 482 to join one to the other, and a spacer bracket 486 disposed opposed the plate 484a mounted between the web members 480 and 482. Each web member 480, 482 is provided with a leading end 488, 490 and a trailing end 492, 494, respectively. The leading end 488 of the web member 490 is fastened to the first pair of mounting tabs 426 and 428 formed at the rear of the body 400 belonging to front cover assembly 370, while the trailing end 492 is fixed to the ledge 468 of the sleeve-like member 460 belonging to the rear cover assembly 372. Similarly, the leading end 490 of the web member 482 is fastened to the second pair of mounting tabs 430 and 432 formed at the rear of the body 400, while the trailing end 494 is fixed to the ledge 470 of the sleeve-like member 460.

In this embodiment, the video capture system 362 takes the form of a single, color digital video camera 500 provided with a relatively compact camera body 502 and a wide angle lens 504 mounted to the camera body 502. Preferably, the video camera 500 is highly sensitive and is capable of delivering high quality and clear images even under low light conditions. In the preferred embodiment, the video camera 500 is capable of capturing images at a frame rate of between 21 and 35 frames per second (FPS). Although, in other embodiments, different frame rates (i.e. greater or lesser frame rates) could be used. An example of a suitable video camera is the CCD color camera model no. KP-D20A distributed by Hitachi Kokusai Electric Canada, Ltd. of Scarborough, Ontario, Canada. Of course, other camera bodies may be used to similar advantage. It will be appreciated that in other embodiments and an analog video camera could be used.

In this embodiment, the wide angle lens 504 is capable of providing 140 degrees field of view. An example of a suitable lens is the Theia™ MY125M ultra wide, multi-megapixel lens manufactured by Theia Technologies LLC of Wilsonville, Oreg., U.S.A. In other embodiments, a different lens may be employed.

The video camera 500 is disposed within the interior of the housing 360 at a location closer to the front cover assembly 370 than to the rear cover assembly 372. The camera body 502 is secured between the web members 480 and 482 and the barrel of the lens 504 is oriented to extend into the body 400 of the front cover assembly 370 with the front of the lens 504 aligned with the large aperture 404 defined in the body 400. The video camera 500 is connected to the 12 pin connector 472 for wired connection to the computer system 17.

While in this embodiment, the video capture system 362 is provided with a single digital video camera, this need not be the case in every application. In other embodiments, the video capture system could include a plurality of digital cameras for capable of capturing moving and/or still images for improved data collection. In still other embodiments, one or more cameras could be analog.

The lighting assembly 364 includes a plurality of LED lights—first, second, third, fourth, fifth, sixth and seventh LED lights 506, 508, 510, 512, 514, 516 and 518—mounted within the sockets 406, 408, 410, 412, 414, 416 and 418, respectively, formed in the body 400 of the front cover plate 370. A glass shield (not shown) fitted within each socket 442, 444, 446, 448, 450, 452 and 454 protects the LED lights from the environment. The lights 506, 508, 510, 512, 514, 516 and 518 are arranged around the camera lens 504 in a substantially circular pattern. In other embodiments, a greater or lesser number of LED lights could be deployed in a different arrangement. Each LED light 506, 508, 510, 512, 514, 516 and 518 includes a plurality of LED diodes. Lights 506, 510 and 516 employ blue LEDs, whereas lights 508, 512, 514 and 518 use white LEDs. Preferably, the ratio of blue LEDs to white LEDs is 3:4—3 blue LEDs for every 4 white LEDs. In alternative embodiments, a different proportion of white and blue LEDs could be employed.

The LED lights 508, 512, 514 and 518 use white LEDs to produce bright illumination within the conduit when the laser beam emitting and diffusion system 366 is not activated. The blue LEDs allow the video capture system 362 to record/register details of the internal surface of the conduit during the scanning process when the laser beam emitting and diffusing system 366 is activated. Advantageously, the blue LEDs illuminate the conduit to allow the operator to see in the conduit, while not interfering with the red light laser traces or contours 16 (shown in FIGS. 1A and 1B) generated by the laser beam emitting and diffusion system 366. Even with the blue LEDs emitting their blue light, the red light contours produced by the laser beam emitting and diffusion system 366 still stand out against the dark conduit background with sufficient contrast to allow a good quality image of the red light contours 16 to be recorded by the video capture system 362 for further processing. Additionally, the illumination provided by the blue LEDs allows for the capture of a good quality image of the location along the conduit being examined, without requiring a second inspection pass over the same length of conduit. As will be appreciated by those skilled in the art, this functionality can be put to good use to assist in determining the location of a corporation stop with some accuracy, after a conduit has been rehabilitated with cured-in-place pipe lining.

In an alternate embodiment where the laser beam emitting and diffusion system produces a different-coloured laser trace, the blue LEDs could be replaced with LEDs of another colour which do not interfere with the laser traces or lessen the contrast of the laser traces against the conduit background. For instance, if the laser beam emitting and diffusion system produces a blue laser beam, red LEDs could be used in the light assembly.

A controller (not shown) governs the actuation of the lighting assembly 364 and the laser beam emitting and diffusing system 366.

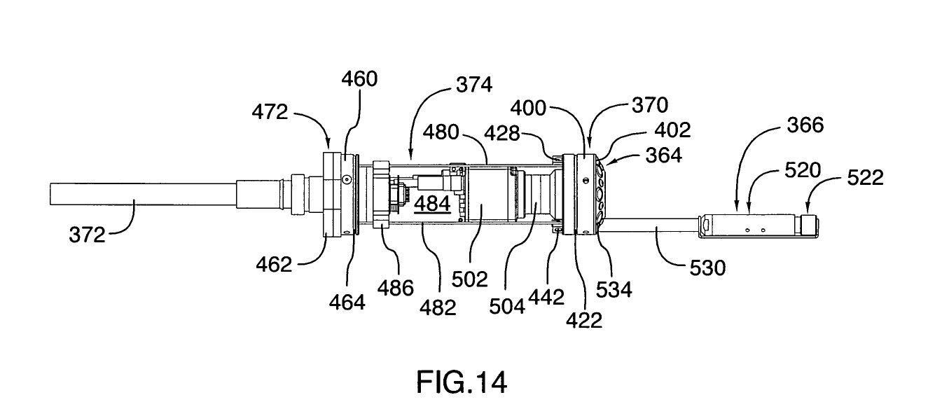

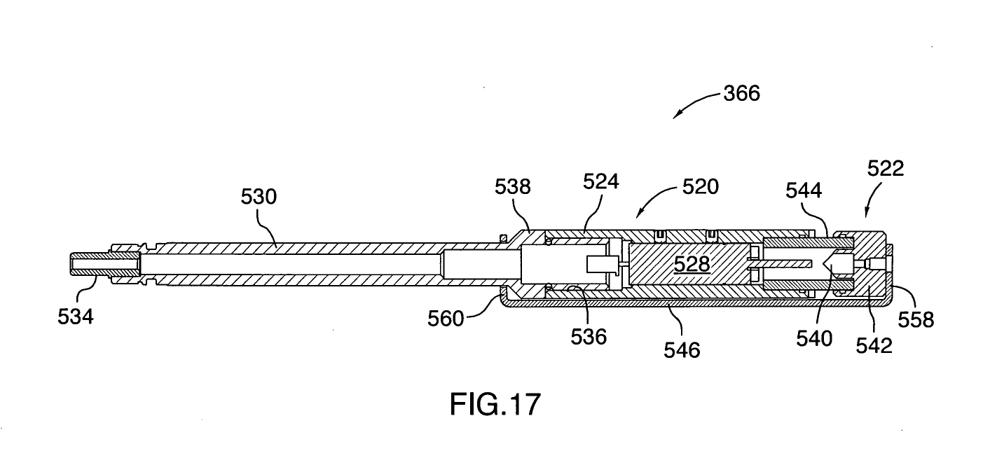

The laser beam emitting and diffusion assembly 366 is supported from the front cover assembly 370 in a cantilevered fashion and extends away therefrom in a leading direction (see FIGS. 14 and 15). Referring to FIG. 17, the assembly 366 includes a laser beam emitting unit 520 which utilizes a linear laser diode, and a mirror prism assembly 522 for diffusing the laser beam produced by the unit 520. The laser beam emitting unit 520 includes a protective sleeve 524, a laser tube 528 fixedly retained within the sleeve 526, and a tubular connector member 530 for connecting the unit 520 to the front cover assembly 370.

The connector member 530 has a rear end 534 provided with threading to allow it to be fastened (i.e. threadingly engaged) to the socket 420 defined in the body 400 of the front cover assembly 370, and a front end 536 which supports or holds the laser tube 528. At a location closer to the front end 532 than to the rear end 534, the connector member 530 has a circumferential flange 538 which provides an abutting surface against which the rear of the sleeve 526 can come to bear. Moving away from the flange 538 and toward the rear end 534, the diameter of the connector member 530 is reduced. The hollow within the connector member 530 accommodates connectors and wiring for connection to the laser tube 528.

The laser tube 528 uses a linear laser diode. In this embodiment, the laser diode is a 100 mA red laser diode. Alternatively, the laser beam emitting unit could employ a more powerful blue laser diode.

The mirror prism assembly 522 is disposed in front of, and spaced away from, the laser tube 528. The assembly 522 includes a conical mirror prism 540 configured to diffuse the laser beam produced by the laser tube 528 along the plane P perpendicular or substantially perpendicular to the beam, and a prism carrier 542 for holding the mirror prism 540. A glass tube 544 extends between the mirror prism 540 and the laser tube 528 to bridge the gap therebetween. A bracket 550 is used to fix the carrier 542 (and mirror prism 540) to the laser beam emitting unit 520. The bracket 550 is generally C-shaped and includes an elongate horizontal portion 556 bounded at either end by vertically extending, front and rear, apertured tabs 558 and 560. The aperture formed in the front tab 558 allows for insertion of a fastener to attach the prism carrier 542 to the bracket 550. The aperture defined in the rear tab 560 is sized somewhat larger to accommodate therethrough the passage of the connector member 530.

A controller (not shown) governs actuation of the laser beam emitting and diffusing system 366 and the lighting assembly 364. The controller can be actuated by the operator from the control booth 18.

As will be explained in greater detail below, the arrangement of the laser beam emitting unit 520 and the mirror prism assembly 522 described above enables a laser beam produced by the laser tube 528 to be directed into the mirror prism 540. The mirror prism 540 diffuses the laser beam along the plane P. At the location where the plane P intersects with the inner surface 13 of the conduit 11, the diffused laser beam traces in visible red light a 360 degree outline, contour or profile 16 of the inner conduit surface 13. This red light profile 16 stands out against the dark background of the conduit. Images of these laser tracings are recorded by the video capture system 362 and constitute, in part, the data that will be processed by the data processing subsystem 15. Any irregularities, discontinuities or protuberances in the inner conduit surface 13 at a particular location within the conduit 11 will be revealed by changes in the intensity of, or breaks in, the laser tracings.

By moving the carriage assembly 22 along the conduit, images of the conduit at different locations along its length can be collected and the images can be used to generate views, plans, models or maps of the conduit. It will thus be appreciated that the data collection subassembly 14 operates much like a large scanner, scanning the inner surface of a conduit being examined.

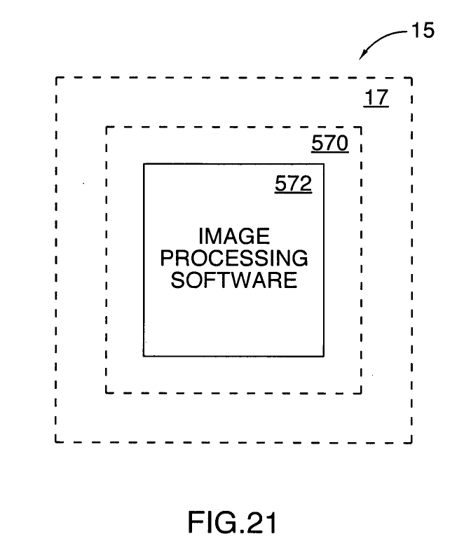

A description of the data processing subsystem 15 now follows with reference to FIGS. 21 to 23. As previously mentioned, in this embodiment, the data processing subsystem is embodied in computer system 17. Conceptually, the computer system 17 includes memory 570 on which may be stored image processing software or application 572 (see FIG. 21). The computer system 17 may be a server computer system configured for use as a workstation or a personal computer that runs the Microsoft Windows™ operating system or other similar operating system, as well as other hardware and software.

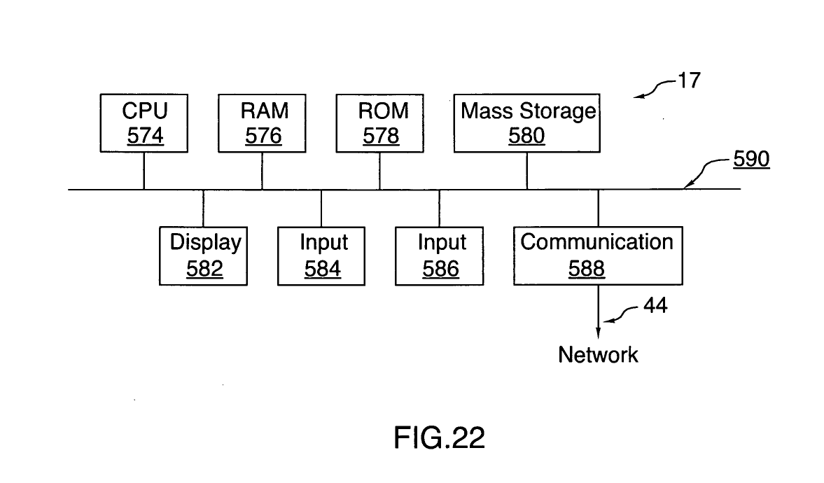

With reference to FIG. 22, the computer system 17 possesses: a central processing unit (CPU) 574, such as, for example, a microprocessor; random access memory 576 (RAM) for temporary storage of information; read-only memory (ROM) 578 for permanent storage of information; a mass storage device 580; a display device 582; input devices 584 and 586; a communication device 588 and a bus system 590 for connecting the various components of the computer system 17.

Memory 570 in which image processing software 572 may be stored and may execute from, may be any of one RAM 576, ROM 578 or mass storage device 580, or any combination thereof. The mass storage device 580 may include any suitable device for storing large volumes of data, such as a magnetic disk or tape, magneto-optical (MO) storage device, or any types of Digital Versatile Disk (DVD) or compact disk (CD-X) storage.

Display device 582 may be any device suitable for displaying alphanumeric, graphical and/or video data, such as a liquid crystal display (LCD), or the like. The input devices 584 and 586 may include any of various types of input devices, for instance, a keyboard, a mouse, a touchpad or a trackpad.

The communication device 588 may be any device suitable for enabling computer system 17 to communicate data in a network environment over a physical or wireless communication link 44.

The image processing software 572 utilizes video image processing techniques to analyze the images captured by the video capture system 362. More specifically, the software 572 is capable of breaking the video image feed into individual frames for further processing and assigning to each frame a linear coordinate and an identification marker. In this embodiment, the linear coordinate represents the displacement or distance traveled of the data collection subsystem 14 from an origin point. This linear coordinate may be based on readings obtained from the counter 38 of the front cable and winch arrangement 37a (the length of cable taken up, or released, by the winch serving as an estimate for the distance traveled by the data collection subsystem 14). In embodiments where the data collection subsystem includes an inertial navigation system, the coordinates assigned to the frames may be actual geographic coordinates calculated by the inertial navigation system.

Based on the variation of intensity in the image, the software 572 is capable of detecting in each frame the red laser tracings with the highest red light intensity. These tracings which delineate the points of intersection between the plane P and the inner surface of the conduit, tend to stand out against the dark (almost black) background. The software 572 filters and converts each frame (originally, captured in colour) to a grey scale image, and selects from such image a plurality of pixels representative of the high light intensities detected in the image. These representative or sample pixels are used to construct or generate a new contour for the conduit shown in the frame. The software 572 is configured to calculate the area delimited by the new contour and to determine the effective diameter for the conduit shown in the frame based on the geometric relationship that exists between the area of a circle and its diameter, as represented by the equation, A=(π)(D²)/4); where A is the area; it is the value of Pi (approximately 3.14159); and D is the diameter. Using this process, the diameter of the conduit can be measured with a relatively high degree of accuracy (approximately, +/−1.0 mm).

In an alternative embodiment, the software could be configured to measure the circumference of the new contour and calculate the effective diameter of the conduit shown in the frame based on the geometric relationship between the circumference of a circle and its diameter, as represented by the equation, C=(π) (D), where C is the circumference; π is the value of Pi (approximately 3.14159); and D is the diameter.

The software 572 is further operable to detect or recognize any breaks in the contour 16 of the inner conduit surface 13 which appear as discontinuities or gaps in the laser tracings. These discontinuities or breaks are indicative of a crack or other opening in the conduit wall 12 through which the laser light escapes. In the case of conduit 11 which is a water main, the discontinuity may be indicative of the presence of a main stop, a pipe branch or a hydrant at that location. When a discontinuity is detected, the software 572 is operable to return all the intensities that correspond to the colour black and plot them on the reconstructed contour. Moreover, the software 572 can calculate the location of the discontinuity within the conduit and its angle of orientation. The angle can be measured to a relatively high degree of accuracy (approximately, +/−1 degree).

The software 572 includes functionality that allows it to merge the data collected and processed (e.g. actual video images; the distance or trajectory traveled by the data collection subsystem 14; the effective diameter of the conduit; or the relative position or location and orientation of features of interest in the conduit) and processed to generate graphical representations of the data that are informative and easy to understand. These graphical representations can be viewed in dynamic format in real time by the operator on the display device 582 located in the control booth 18, transmitted in real time to other computer systems for remote viewing, and/or stored in memory 570 (e.g. in mass storage device 580).

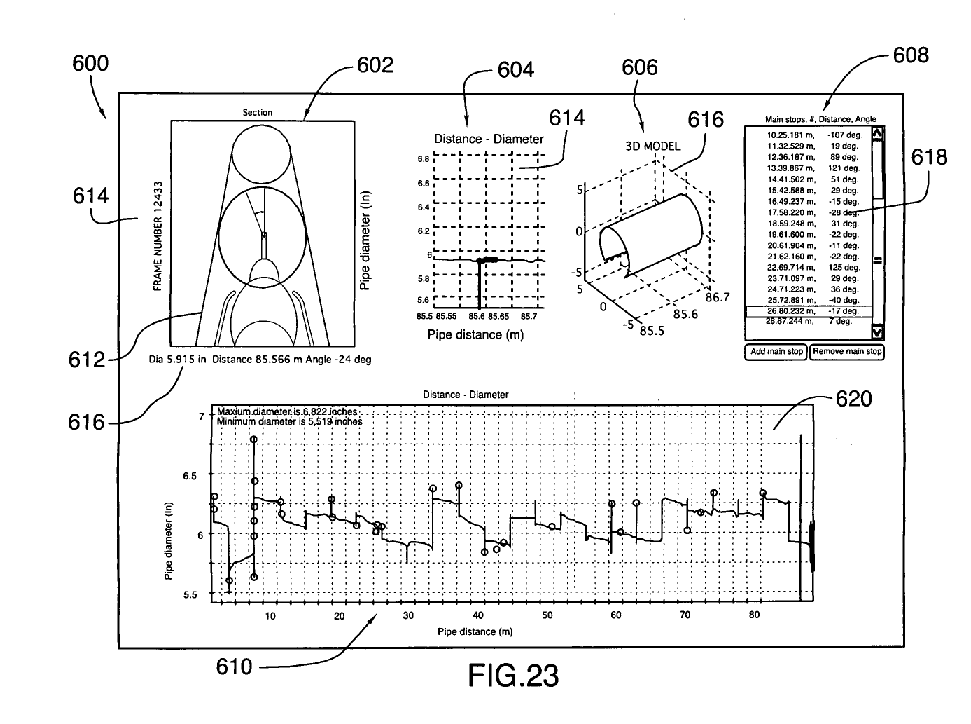

FIG. 23 shows a screen shot 600 of exemplary graphical representations of data outputted by the software 572 and displayed on the display device 582. In this screen shot 600, the data is displayed differently in a plurality of fields 602, 604, 606, 608 and 610. Field 602 contains a frame 612 taken from the video footage showing the conduit at a particular location. The contour or profile of the inner surface of the conduit outlined by the laser tracings is visible as is a discontinuity or break in the contour indicating the presence of a main stop (or other feature). The frame 612 can be seen to be identified by an identification marker 614 (in this case, a series of numbers) positioned vertically to the left of the frame 612. Arranged horizontally below the frame 612, is additional information 616, namely, the effective diameter of the conduit at that particular location, and the relative position (i.e. distance from a point of origin) and angle of orientation of the main stop within the conduit.

Field 604 contains a graph 614 which plots the effective diameter of the conduit (in the y-axis) against the relative position (i.e. distance from a point of origin) (in the x-axis), for only a selected segment of the conduit.

Field 606 presents the data in a 3-dimensional CAD model 616 which plots the effective diameter (in the y-axis) versus the effective diameter of the conduit (in the x-axis) versus the relative position (i.e. distance from a point of origin) (in the z-axis). In other embodiments, other CAD models (2-dimensional or 3-dimensional) could be generated. For alternate CAD models could incorporate the geographic coordinates calculated by an inertial navigational system.

Field 608 features a table 618 which provides information about the main stops encountered within the conduit—their relative locations and angles of orientation. Of course, this or similar tables could provide additional information on these main stops (e.g. geographic coordinates) or information about other features of interest within the conduit.

Field 610 contains a graph 620 generally similar to graph 614 shown in field 604 in that it too plots the effective diameter of the conduit (in the y-axis) against the relative position (i.e. distance from a point of origin) (in the x-axis). However, the graph 620 plots these values for the entire length of the conduit.

The fields 602, 604, 606, 608 and 610 are merely examples of the graphical representations that the image processing software 572 may output. In other embodiments, the software could be configured to output different graphical representations than those described above (e.g. maps, spreadsheets or drawings).

An exemplary deployment of the conduit scanning, mapping and measuring system 10 will now be described in greater detail with reference to FIGS. 1A and 1B. Two spaced apart, first and second access pits 630 and 632 for accessing opposing ends of the conduit segment to be inspected, are selected and prepared. The first access pit 630 serves as the entry point through which the data collection subsystem 14 may be inserted into the conduit 11, while the second access pit 632 is intended as an exit. Disposed at the first and second access pits 630 and 632 are the front and rear cable and winch arrangements 37a and 37b, respectively. Cables from the cable and winch arrangements 37a and 37b are tied to the lugs 256 provided on the runner member 240 of the third leg assembly 36. Thereafter, the data collection subsystem 14 is placed in the first access pit 630 and introduced into the conduit 11. Preferably, the leg assemblies 30 are extended to adjust the height of the carriage 28 to allow the laser beam emitting and diffusion system 366 (and more specifically the laser tube 528 and the mirror prism 540) to be carried at, or at least very close to, the theoretical geometric centre of the conduit 11. However, while preferred, this is not required because the image processing software 572 can compensate for the laser tube 528 and the mirror prism 540 being off-centre.

Once the carriage assembly 28 is set up for travel within the conduit 11, the light assembly 362, the laser beam emitting and diffusion system 366 and the video capture system 364 are actuated. More specifically, the blue LED lights 506, 510 and 516 are switched on; the laser tube 528 is energized; and the video camera 500 begins recording digital video images of the interior of the conduit 11. Care is taken to ensure that the computer system 17 is operation ready and the data connection between the data collection subsystem 14 and data processing system 15 is functional such that the video footage captured by the video camera 500 can be viewed on the display device 582 by the operator.

The front cable and winch arrangement 37a is actuated to urge the carriage assembly 28 to travel within the conduit 11 in a continuous manner. Preferably, the rate of travel of the carriage assembly is 3 to 5 metres per minute. In other embodiments, a different (faster or slower) rate of travel may be used.

As the carriage assembly 28 moves through the conduit 11, the electrical counter 38a measures the length of cable paid out by the cable and winch arrangement 37a which serves as a good measure of the distance traveled by the carriage assembly within the conduit 11. Contemporaneously with the displacement of the carriage assembly 28, the laser beam emitting unit 520 generates a red laser beam that passes through the mirror prism 540 and is diffused along the plane P. At the location where the plane P intersects with the inner surface 13 of the conduit 11, the diffused laser beam traces in visible red light the contour 16 of the inner conduit surface 13. The blue LED lights 506, 510 and 516 enable the operator to view features of the inner surface of the conduit as the red light contours are being generated. Advantageously, the blue light tends not to lessen the contrast of the red light contours against the dark conduit background. The video capture system 364 records these laser light tracings and the video footage is transmitted to the computer system 17 via the 12-pin connector 472.

The computer system 17 receives video footage and other data and runs the image processing software 572 to process same. The software 572 breaks the video image feed into individual frames and assigns to each frame a linear coordinate and an identification marker. Thereafter, the software 572 detects in each frame the red laser tracings with the highest red light intensity. It filters and converts each frame to a grey scale image, and selects from such image a plurality of pixels representative of the high light intensities detected in the image. A new contour for the conduit shown in the frame is then constructed using these representative pixels. Subsequently, the area delimited by the new contour is calculated and the effective diameter for the conduit shown in the frame is determined. When a discontinuity or break in the contour is detected, the software 572 calculates the location of the discontinuity within the conduit and its angle of orientation. Finally, the software 572 merges the data collected and processed to generate graphical representations such as those shown in the screenshot of FIG. 23.

By allowing an operator to view the actual video footage (of good quality) of a section of conduit alongside a graphical representation of the diameter at that section, an operator can better appreciate the nature of a non-roundness in a recently rehabilitated conduit and identify whether the non-roundness is caused by a bunching of cured-in-place liner or whether it points to the location of the corporation stop. This tends to reduce errors in determining the location of corporation stops.

From the foregoing description, it will be appreciated that the conduit scanning, mapping and measuring system 10 is relatively simple to deploy in a conduit. The data collection subsystem 14 is relatively easy to set up and operate. It is compact and robust and its ability to adjust its profile or size to fit within conduits of variable sizes tend to make versatile and well-suited for use in different field applications. Advantageously, the subsystem 14 is configured for collecting information in dynamic mode (while moving through the conduit) for reduced inspection times. A further advantage lies in the fact that the subsystem 14 is able to capture good quality, useable raw video footage while simultaneously permitting laser profiling of the conduit being inspected, thereby obviating the need for two inspection passes over the same length of conduit. This is made possible by having a light assembly that is operable to emit light which does not substantially lessen the contrast of the laser light contours against the dark conduit background, thereby allowing a good quality image of the laser light contours to be recorded for further processing. The data processing subsystem 15 is optimized for rapid data processing (at a rate of approximately 0.1 second/frame) in real time while still providing results with a relatively high degree of accuracy. A further benefit of the subsystem 15 is that it allows for multiple points of data collected and processed to be merged or linked to each other to create or output useful and informative graphical representations of data about the conduit under examination.

While in this embodiment, the conduit 11 is a municipal conduit located below ground, it will be recognized that in alternative embodiments the conduit could be used to convey other pressurized or non-pressurized fluids (i.e. liquids or gasses) or slurries and could be located above ground. For example, the conduit could be an oil pipe or pipeline, an HVAC duct, a gas main, sewer line, a storm drain, an exhaust pipe, an industrial effluent line or the like. Moreover, the conduit or pipe could carry fibre optics or data transmission cables. Accordingly, it should be appreciated that a conduit scanning, mapping and measuring system constructed in accordance with the principles of the present invention could be deployed to similar advantage in such conduits.

While the system would be put to good use in applications relating to conduit inspection, maintenance and rehabilitation, it may have broader applications and thus could also be adapted for use in applications unrelated to conduit rehabilitation, for example, tunnel boring applications. In such applications, the system could be employed to scan and map a tunnel bored in the ground.

From the foregoing disclosure, it will be apparent that the data processing subsystem and the image processing methods described above may be computer implemented and may be embodied in software, either in whole or in part. However, it should be appreciated that the principles of the present invention could be implemented to similar advantage by hardwired circuitry used in place of, or in combination with, software instructions. Thus, the present invention is not limited to any specific combination of hardware circuitry and software.

Although the foregoing description and accompanying drawings relate to specific preferred embodiments of the present invention as presently contemplated by the inventor(s), it will be understood that various changes, modifications and adaptations, may be made without departing from the spirit of the invention.

What is claimed is:

1. A conduit scanning and mapping system comprising:
a data collection subsystem having:
a carriage assembly sized to fit within a conduit for travel therethrough;
an equipment module supported on the carriage assembly; the equipment module including a housing, a video capture system and a lighting assembly accommodated within the housing, and a laser beam emitting and diffusion assembly attached to the housing forwardly of the video capture system;
the laser beam emitting and diffusion assembly being operable to emit a laser beam and diffuse the laser beam along a plane P substantially perpendicular to the laser beam so as to trace a visible light contour where the plane P intersects the inner surface of the conduit; the laser beam being light of a first colour;
the video capture system being operable to record images of the conduit and the visible light contour generated by the laser beam emitting and diffusion assembly;
the lighting assembly including at least one LED light capable of emitting light of a second colour; the light of the second colour being different than the light of the first colour; the light of the second colour being selected so as provide sufficient illumination within the conduit to reveal features of the conduit when the at least one LED light is activated, while not substantially lessening the contrast of the visible light contour against the dark background formed by the conduit thereby allowing the images of the visible light contour of a sufficient quality to be captured for further processing; and
a data processing subsystem in data communication with the data collection subsystem;
the data processing subsystem being operable to process the images of the conduit and the visible light contour and to generate therefrom digital views of the conduit.

2. The conduit scanning and mapping system of claim 1 wherein the light of the first colour is red.

3. The conduit scanning and mapping system of claim 2 wherein the light of the second colour is blue.

4. The conduit scanning and mapping system of claim 3 wherein the lighting assembly includes a plurality of LED lights, the at least one LED light being a first LED light; the plurality of LED lights including a second LED light capable of emitting light of a third colour, the light of the third colour being different than the light of the second colour.

5. The conduit scanning and mapping system of claim 4 wherein the light of the third colour is white.

6. The conduit scanning and mapping system of claim 3 wherein:
the lighting assembly includes a first set of LED lights capable of emitting light of the first colour and a second set of LED lights capable of emitting light of the second colour, the at least one LED light forming part of the first set of LED lights;
the LED lights of the first and second sets being disposed in an alternating fashion about the front of the housing.

7. The conduit scanning and mapping system of claim 6 wherein:
the first set of LED lights includes first, second and third LED lights; and
the second set of LED lights includes fourth, fifth, sixth and seventh LED lights.

8. The conduit scanning and mapping system of claim 1 wherein the light of the first colour is blue.

9. The conduit scanning and mapping system of claim 3 wherein the light of the second colour is red.

10. The conduit scanning and mapping system of claim 1 wherein the carriage assembly includes a cradle.

11. The conduit scanning and mapping system of claim 10 wherein the carriage assembly includes a plurality of leg assemblies supporting the cradle.

12. The conduit scanning and mapping system of claim 11 wherein the plurality of leg assemblies is selected from the group consisting of: (a) adjustable leg assemblies; and (b) non-adjustable leg assemblies.

13. The conduit scanning and mapping system of claim 11 wherein the plurality of leg assemblies includes first, second and third leg assemblies; the third leg assembly being disposed between the first and the second leg assemblies.

14. The conduit scanning and mapping system of claim 11 wherein each leg assembly of the plurality has a runner member configured to bear against the inner surface of the conduit, a scissor-leg arrangement and a bracket member for attaching the runner member to the scissor leg-arrangement.

15. The conduit scanning and mapping system of claim 1 wherein the video capture system includes a wide angle lens operatively connected to a video camera.

16. The conduit scanning and mapping system of claim 1 wherein the laser beam emitting and diffusion assembly includes a laser beam emitting unit and mirror prism assembly for diffusing the laser beam produced by the laser beam emitting unit.

17. The conduit scanning and mapping system of claim 1 wherein the data processing subsystem includes a computer system disposed at a location selected from the group consisting of: (a) a location physically proximate the conduit and (b) a location remote from the conduit.

18. The conduit scanning and mapping system of claim 1 wherein the data collection subsystem is in real-time data communication with the data processing subsystem.

19. The conduit scanning and mapping system of claim 1 wherein the data communication between the data collection subsystem and the data processing subsystem is achieved using a connection selected from the group consisting of: (a) a wired connection; and (b) a wireless connection.

20. A method of scanning and mapping a conduit, the method comprising the steps of:
providing a conduit mapping and scanning system, the system including a data collection subsystem and a data processing subsystem in data communication with the data collection subsystem, the data collection subsystem having:
a carriage assembly sized to fit within a conduit for travel therethrough;
an equipment module supported on the carriage assembly; the equipment module including a housing, a video capture system and a lighting assembly accommodated within the housing, and a laser beam emitting and diffusion assembly attached to the housing forwardly of the video capture system; the laser beam emitting and diffusion assembly capable of emitting light of a first colour; the lighting assembly including at least one LED light capable of emitting light of a second colour; the light of the second colour being different than the light of the first colour;
moving the carriage assembly through the conduit;
illuminating the conduit with the at least one LED light;
emitting from the laser beam emitting and diffusion assembly a laser beam and diffusing the laser beam along a plane P substantially perpendicular to the laser beam;
tracing a visible light contour on the conduit where the plane P intersects the inner surface of the conduit;
recording images of the conduit and the visible light contour using the video capture system as the carriage assembly moves through the conduit; the recorded images showing the conduit sufficiently illuminated to reveal features of the conduit and the visible light contour sufficiently contrasted against the dark background formed by the conduit;
processing the recorded images of the conduit and the visible light contour and generating therefrom digital views of the conduit.

21. A method of locating a corporation stop in a conduit rehabilitated with a cured-in-place pipe liner, the method comprising the steps of:
providing a conduit mapping and scanning system, the system including a data collection subsystem and a data processing subsystem in data communication with the data collection subsystem, the data collection subsystem having:
a carriage assembly sized to fit within a conduit for travel therethrough;
an equipment module supported on the carriage assembly; the equipment module including a housing, a video capture system and a lighting assembly accommodated within the housing, and a laser beam emitting and diffusion assembly attached to the housing forwardly of the video capture system; the laser beam emitting and diffusion assembly capable of emitting light of a first colour; the lighting assembly including at least one LED light capable of emitting light of a second colour; the light of the second colour being different than the light of the first colour;
moving the carriage assembly through the conduit;
illuminating the conduit with the at least one LED light;
emitting from the laser beam emitting and diffusion assembly a laser beam and diffusing the laser beam along a plane P substantially perpendicular to the laser beam;
tracing a visible light contour on the conduit where the plane P intersects the inner surface of the conduit;
recording images of the conduit and the visible light contour using the video capture system as the carriage assembly moves through the conduit; the recorded images showing the conduit sufficiently illuminated to reveal features of the conduit and the visible light contour sufficiently contrasted against the dark background formed by the conduit;
processing the recorded images of the conduit and the visible light contour and generating therefrom digital views of the conduit;
visually identifying the location of the corporation stop from the recorded images of the conduit and the digital views of the conduit.
